(19) United States
(12) Patent Application Publication
(10) Pub. No.: US 2013/0198678 A1
(43) Pub. Date: Aug. 1, 2013

(54) METHOD AND APPARATUS FOR DISPLAYING PAGE IN TERMINAL

(71) Applicant: SAMSUNG ELECTRONICS CO., LTD., Suwon-si (KR)

(72) Inventors: Shinjun LEE, Yongin-si (KR); Sanghyup LEE, Suwon-si (KR); Amir DROR, Tel Aviv (IL); Kyungsoo HONG, Netanya (KR); Ofir ENGOLZ, Kfar Saba (IL)

(73) Assignee: SAMSUNG ELECTRONICS CO., LTD., Suwon-si (KR)

(21) Appl. No.: 13/739,777

(22) Filed: Jan. 11, 2013

(30) Foreign Application Priority Data
Jan. 31, 2012 (KR) 10-2012-0010106
Feb. 29, 2012 (KR) 10-2012-0021310

(51) Int. Cl. G06F 3/0483

(52) U.S. Cl. CPC G06F 3/0483
USPC 715/776

(57) ABSTRACT

A method and an apparatus for displaying a page are capable of transferring a realistic feeling like reading a paper book when a user reads an electronic book. The method of displaying a page of a portable terminal including a touch screen, includes: displaying a page of an electronic book; detecting a point which corresponds to a user input with respect to the displayed page; detecting a moving direction associated with the user input; and displaying the page as being convexly curved in response to the detected point and the moving direction associated with the user input to animate a page turning operation.

### CROSS-REFERENCE TO RELATED APPLICATIONS

This application claims priority from Korean Patent Application No. 10-2012-0010106 filed Jan. 31, 2012, and Korean Patent Application No. 10-2012-0021310 filed Feb. 29, 2012, the contents of which are incorporated herein by reference in their entirety.

### BACKGROUND

1. Field

Methods and apparatuses consistent with exemplary embodiments of this disclosure relate to a page display method and apparatus in a terminal having a reader function of an electronic book, and more particularly, to a method and an apparatus for displaying a page according to user input information associated with the page.

2. Description of the Related Art

In general, an electronic book generally refers to a digital book allowing a user to view it as a book by recording information such as text or images in an electronic medium. The user may view an electronic book displayed using a terminal including an electronic book reader function. Further, the user may conveniently purchase and read a desired electronic book anytime and anywhere using a smart phone or a tablet personal computer (PC). Accordingly, use of the electronic book has grown in popularity.

In general, the terminal turns pages of an electronic book according to input information of the user. However, the page turning is very simple. That is, according to a method and an apparatus for turning pages according to the related art, it is difficult to provide the user with the feeling of turning pages as an actual page book is operated. When input information of the user associated with paging turning, for example, push of a next page button is detected, the method and an apparatus for turning pages according to the related art replace a currently displayed page by a next page. Such a replacement scheme simply browses a web page rather than actually turning pages.

Further, terminals may include a touch screen. The terminal detects a touch gesture while displaying an optional page and displays a page of an electronic book corresponding to the detected touch gesture. That is, in the terminal using the touch screen, a method and an apparatus for displaying an electronic book provide an animation turning the page. When the user turns the page, the terminal according to the related art provides an animation in which a current page (that is, front surface) is gradually folded and a next page (that is, back surface) is viewed regardless of a touched point or a direction of a drag.

### SUMMARY

One or more exemplary embodiments provide a method and an apparatus for displaying a page capable of providing a realistic feeling like reading a paper book when a user reads an electronic book.

One or more exemplary embodiments also provide a method and an apparatus for displaying a page which provides a realistic animation turning the page.

In accordance with an aspect of an exemplary embodiment, there is provided a method of displaying a page of a portable terminal including a touch screen, the method including: displaying a page of an electronic book; detecting a point which corresponds to a user input with respect to the displayed page; detecting a moving direction associated with the user input; and displaying the page as being convexly curved in response to the detected point and the moving direction associated with the user input to animate a page turning operation.

In accordance with an aspect of another exemplary embodiment, there is provided a portable terminal including: a touch screen configured to display a page of an electronic book; a sensor configured to detect a gradient of the portable terminal; and a controller configured to detect a continuous motion of a touch of the screen with respect to the displayed page, and control the touch screen to display the page as being convexly curved in response to the detected continuous motion of the touch and the detected gradient of the portable terminal to animate a page turning operation.

### BRIEF DESCRIPTION OF THE DRAWINGS

The above and/or other aspects will be more apparent from the following detailed description of exemplary embodiments in conjunction with the accompanying drawings, in which:

FIG. 1 is a block diagram illustrating a configuration of a portable terminal according to an exemplary embodiment;

FIG. 2 is a block diagram illustrating a configuration of a controller according to an exemplary embodiment;

FIGS. 3A and 3B are exemplary diagrams illustrating a page mesh according to an exemplary embodiment;

FIG. 4 is a flowchart illustrating a method of displaying a page according to an exemplary embodiment;

FIG. 5 is a flowchart illustrating a method of transforming a page according to an exemplary embodiment;

FIG. 6 is a flowchart illustrating a method of turning pages according to an exemplary embodiment;

FIG. 7 is a flowchart illustrating a method of describing setting an electronic book according to an exemplary embodiment;

FIG. 8A is an exemplary diagram illustrating a screen for setting environments of the portable terminal;

FIG. 8B is an exemplary diagram illustrating a screen for setting environments of the electronic book;

FIGS. 9 to 33 are exemplary diagrams illustrating screens for describing a method of displaying a page according to an exemplary embodiment;

FIG. 34 is a flowchart illustrating a method of displaying a page according to another embodiment;

FIGS. 35 to 44 are exemplary diagrams illustrating a screen for describing a method of displaying screens according to another embodiment;

FIG. 45 is a flowchart illustrating a method of displaying a page according to still another embodiment; and

FIG. 46 is an exemplary diagram illustrating a screen for describing a method of displaying screens according to still another embodiment.

### DETAILED DESCRIPTION OF EXEMPLARY EMBODIMENTS

Exemplary embodiments are described below with reference to the accompanying drawings in detail. The same reference numbers are used throughout the drawings to refer to the same or like parts.

As used herein, the term “bookmark” is defined as a space capable of storing reading items. A displayed form of the bookmark is various, for example, may be a folder or a bookshelf shape. The reading items stored in the bookmark may be a folder indicated as an image associated with binding of a plurality of electronic books, reading schedule information of an electronic book (e-book) to which a reading schedule is set, and accessories for decorating the bookmark.

In an embodiment of the present invention, the ‘e-book’ may be classified by fields. The fields may chiefly include a book, a textbook, a magazine, a newspaper, a comic, and a specialty publication. The fields may be classified in detail. For example, the book may be classified into a novel, an essay, and a poem. The e-book may include text, an image, audio, video, and user input information. The user input information may be defined as information which the user inputs separately or a displayed page. For instance, the user input information may be memo, highlight, images and bookmarks. The user input information may include handwriting using a touch input unit (e.g., finger of a user or a stylus pen, etc.).

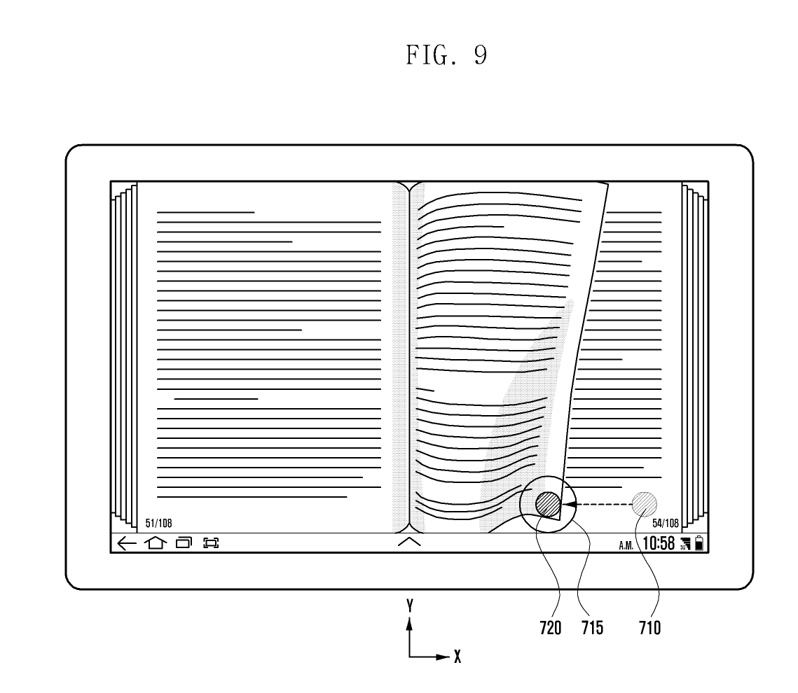

As used herein, the term “animation” refers to a motion of displayed contents, particularly, a page or a function of a terminal performing the motion. In particular, the animation may include a turning shape of pages in response to input information of the user (e.g., touch, etc.) or a three-dimensionally convexly transformed shape (refer to FIGS. 9 to 33) of the page when the user turns the page.

In an embodiment of the present invention, the term ‘page mesh’ is defined as geometrical information of a page. The page mesh comprises a plurality of nodes and links connecting the nodes to each other. A suitable weight value is allocated to each of the nodes and a suitable elastic value is allocated to each of the links. The elastic value may be allocated differently according to properties of a paper transferring an actual feeling to the user. For instance, when the page is set thickly (that is, when the weight value is great), a larger elastic value may be allocated. Conversely, when the page is relatively thin, a smaller elastic value may be allocated. A large weight value may be allocated to nodes located in an inner direction (e.g., spine). Since location change in nodes located in a relatively outer direction (e.g., book edges) is larger than nodes location in an inner direction, a small weight value may be allocated to the nodes located in a relatively outer direction. The same weight value may be allocated to all the nodes.

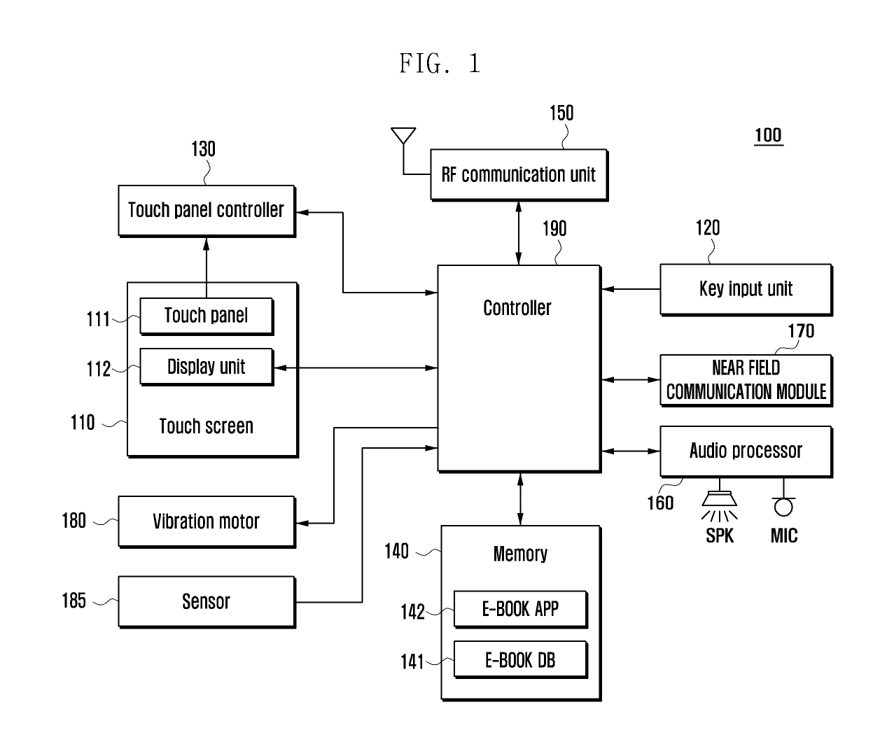

Virtual forces applied to each node may be two types. First, there is virtual internal power such as an elastic force. Further, there is virtual external power such as virtual gravity or virtual human power. The virtual gravity power is defined by power attracting the node in a downward direction. If a display screen on which a page is displayed is an XY plane, and a viewpoint of the user is a positive direction of a Z axis in the XY plane, a lower portion of the XY plane may be a negative direction of the Z axis. The Z axis is perpendicular to the XY plane. The Z axis is not an actual axis, but instead is a virtual axis for three-dimensionally expressing a virtual page. The gravity may be equally applied to all the nodes. However, the gravity may be applied differently according to properties of a paper transferring an actual feeling to the user. For example, when the user lifts and turns a page of an actual paper book, the gravity is slowly reduced when a corresponding virtual page corresponds to a thin paper material and is rapidly reduced when the corresponding virtual page corresponds to a relatively thick paper material. A following table illustrates thicknesses by types of virtual pages. Referring to FIG. 1, a pamphlet may be relatively and rapidly reduced as compared with an insert. That is, a transformed degree of the page may be changed according to a thickness or a material set to a displayed paper.

TABLE 1

| | |
|---|---|
| Insert inserted into a newspaper | 52.3 g/m² |
| Body of magazine, advertising paper | 64 g/m² |
| ticket, cover of weekly newspaper, pamphlet | 127.9 g/m² |
| Cover of fashion newspaper, name card | 157 g/m² |
| Sketchbook | 200 g/m² |
| Printing paper | 75 g/m² |

Virtual human power corresponds to power which the user applies to the virtual page. The virtual human power may be determined, for example, based on a user gesture (e.g., user touch motion) with respect to a touch screen. The user gesture may include a vector value such as a size (speed, moving distance) and a direction such as flick, drag, or press. A node to which virtual human power is applied by the user gesture moves in a direction corresponding to the touch motion. In this case, the virtual human power may be transferred to other nodes through links.

As a result, a sum of the internal power and the external power is applied to respective nodes in the page mesh. If a virtual human power is applied to a displayed page, a controller of a terminal (e.g., mobile smart phone) calculates virtual powers applied to respective nodes of a page mesh based on applied user gesture (e.g., human touch movement speed and direction), and transforms the page mesh based on virtual powers of the respective calculated nodes. A moving distance of a target node is multiplied by speed to obtain acceleration, a weight of a corresponding target node is multiplied by the acceleration to obtain power. Methods of calculating the power are known in the art, and thus a detailed description is omitted. Next, the terminal reflects the transformed page mesh to a page to generate an animation. A procedure of generating the animation based on the human power may be executed in an Application Processor (AP), a Central Processing Unit (CPU), or a Graphics Processing Unit (GPU).

In an embodiment of the present invention, a ‘pointer’ is means indicating an optional point of the page. In a terminal including a touch screen, the pointer may be a touch input unit such as a finger, a stylus pen, etc.). That is, the touch screen detects touch of the touch input unit and transfers associated detection information (e.g., touch location, touch direction, etc.) to the controller. The pointer may be a write pen, a mouse, and a track ball as well as a finger or a stylus pen. Herein, the exemplary embodiments will described in the case in which a pointer is a touch input unit, such as a finger or a stylus pen, but the exemplary embodiments are not limited thereto.

The method and apparatus for displaying a page according to embodiments of the present invention are applicable to electronic devices of various types including a reader function of an e-book. Particularly, the method and apparatus for displaying a page according to embodiments of the present invention are applicable to a portable terminal including an input unit, for example, a touch screen. Such a portable terminal may be a smart phone, a tablet PC, a hand-held PC, a Portable Multimedia Player (PMP), an e-book reader, and a Personal Digital Assistant (PDA). For the purpose of convenience of the description, it is assumed that a method and an apparatus for displaying an e-book according to the present invention are applicable to a portable terminal including a touch screen.

The method and apparatus for displaying a page according to the present invention a provides a technique which detects input information associated with user gesture while displaying a page, transforms a page mesh in response to the detected input information, reflects the transformed page mesh onto the page to generate an animation, and displays the generated animation. Particularly, the exemplary embodiments provide an animation in which a page is actually turned. In the description below, detailed descriptions of well-known functions and structures incorporated herein may be omitted to avoid obscuring the subject matter.

FIG. 1 is a block diagram illustrating a configuration of a portable terminal according to an exemplary embodiment. Referring to FIG. 1, a portable terminal 100 may include a touch screen 110 having a touch panel 111 and a display unit 112, a key input unit 120, a touch panel controller 130, a memory 140, a radio frequency (RF) communication unit 150, an audio processor 160, a speaker SPK, a microphone MIC, a near field communication module 170, a vibration motor 180, a sensor 185, and a controller 190.

The touch panel 111 may be provided on the display unit 112, and generates and transfers a signal (e.g., touch event) to the controller 190 in response to a user gesture input to the touch panel 111. The touch panel 111 may be implemented by an add-on type placed on the display unit 112, an on-cell type inserted in the display unit 112, or an in-cell type. The controller 190 may detect a user gesture from a touch event input from the touch screen 100 and control the constituent elements.

The user gesture may be classified as a touch and a touch gesture. Here, the touch gesture may include tap, double tap, long tap, drag, drag & drop, and flick. The touch is an operation where a user presses one point of a screen using a touch input unit (e.g., finger or stylus pen). The tap is an operation where the user touches (presses) a point on the screen with the touch input unit without moving the touch input unit while touching the screen and then releases touch. The double tap is an operation where a user performs a tap two times in quick succession with the touch input unit. The long tap is an operation where a user touches (presses) a point on screen with the touch input unit without moving the touch input unit while touching the screen and then releases the touch after touching the point longer than the tap. The drag is an operation that moves a touch input unit in a predetermined direction while touching the screen, i.e., without lifting the touch input unit. The drag & drop is an operation that releases the touch of a touch input unit after a drag. The flick is an operation that moves a touch input unit at high speed while touching the screen, i.e., like flipping. The touch means a state in which the touch input unit contacts the touch screen, and the touch gesture means a motion from a start of the touch on the touch screen to a release of the touch. Further, a resistive type, a capacitive type, and a pressure type are applicable to the touch panel 111.

The display unit 112 converts image data input from the controller 190 into an analog signal, and displays the analog signal under the control of the controller 190. That is, the display unit 112 may provide various screens according to use of the portable terminal, for example, a lock screen, a home screen, an application (hereinafter referred to as an ‘App’) execution screen, a menu screen, a keypad screen, a message creation screen, and an Internet screen. A lock screen may be an image displayed when a screen of the display unit 112 become large. When a specific touch event for releasing the locking occurs, the controller 190 may convert a displayed image from a lock screen into a home screen or an App execution screen. The home screen may be defined as an image including a plurality of App icons corresponding to a plurality of Apps, respectively. When one is selected from a plurality of App icons by a user, the controller 190 may execute a corresponding App, for example, electronic book App, and convert a displayed image into an execution screen.

The display unit 112 may display animation images under the control of the controller 190. In an embodiment, the display unit 112 may display a form in which pages are turned, a form in which a shadow is generated in the pages, and a form in which the pages are crumpled.

The display unit 112 may be configured in the form of a flat panel display such as a Liquid Crystal Display (LCD), an Organic Light Emitted Diode (OLED) display, and an Active Matrix Organic Light Emitted Diode (AMOLED) display.

The key input unit 120 may include a plurality of input keys and function keys for receiving numeric or character information and setting various functions. The function keys may include arrow keys, side keys, and hot keys set such that a specific function is performed. The key input unit 120 generates and transfers a key signal associated with user setting and function control of the portable terminal 100 to the controller 190. The key signal may be classified as an on/off signal, a volume control signal, and a screen on/off signal. The controller 190 controls the foregoing constituent elements in response to the key signal. The key input unit 120 may include a QWERTY keypad, a 3*4 keypad, or a 4*3 keypad having a plurality of keys, but is not limited thereto. When the touch panel 111 of the portable terminal is supported in the form of a full touch screen, the key input unit 120 may include only at least one side key for screen on/off and portable terminal on/off, which is provided in a side of a case of the portable terminal 100.

The touch panel controller 130 is connected to the touch panel 111, receives a touch event from the touch panel 111, and Analog to Digital (AD)-converts and transfers the received touch event to the controller 190. The controller 190 detects a user gesture from the transferred touch event. That is, the controller 190 may detect a touched location, a moving distance of touch, a motion direction of the touch, and speed of the touch.

The memory 140 may store an Operating System (OS) of the portable terminal, an App and various data necessary for the exemplary embodiment. The memory 140 may include a data region and a program area.

The data area of the memory 140 may store data, namely, an e-book, a contact point, an image, a document, video, messages, mail, music, an effect sound generated from the portable terminal 100 or downloaded from the outside according to use of the portable terminal 100. The data area may store the screen which the display unit 112 displays. The menu screen may include a screen switch key (e.g., a return key for returning to a previous screen) for switching the screen and a control key for controlling a currently executed App. The data area may store data which the user copies from messages, photographs, web pages, or documents for copy & paste. The data area may store various preset values (e.g., screen brightness, presence of vibration during generation of touch, presence of automatic rotation of the screen) for operating the portable terminal.

The data area may store an e-book DB 141 including a plurality of e-books. The data area may store reading situation information with respect to a plurality of stored e-books. The reading situation information may include stored date of an e-book, the read number of an e-book, a read page, a read date, a non-read page, and user input information. The user input information may be displayed simultaneously with displaying a corresponding page.

The program area of the memory 140 may store an Operating System (OS) and various Apps for booting the portable terminal and operating the foregoing constituent elements. In detail, the program area may store a web browser for accessing an Internet, an MP3 player for playing a sound source, and a camera App for photographing, displaying, and storing a subject. The program area may store an e-book App 142 capable of performing a physically based simulation.

The RF communication unit 150 performs voice call, image call, or data communication under the control of the controller 190. To do this, the RF communication unit 150 may include an RF transmitter for up-converting a frequency of a transmitted signal and amplifying the converted signal, and an RF receiver for low-noise-amplifying a frequency of a received signal and down-converting the amplified signal. The RF communication unit 150 may include a mobile communication module (e.g., a 3rd-generation (3G) mobile communication module, 3.5-generation mobile communication module, a 4th-generation (4G) mobile communication module, etc.), and a digital broadcasting module (e.g., DMB module).

The audio processor 160 receives audio data from the controller 190, D/A-converts the received audio data into an analog signal, and outputs the analog signal to the speaker SPK. The audio processor 160 receives an analog signal from the microphone MIC, A/D converts the received analog signal into audio data, and provides the audio data to the controller 190. The speaker SPK converts an analog signal received from the audio processor 160 into a sound wave and outputs the sound wave. The microphone MIC converts a sound wave from a person or other source into the analog signal. Particularly, the audio processor 160 according to the present invention outputs feedback (e.g., effect sound in which pages are turned) to the speaker SPK. The effect sound may be changed according to attribute information (e.g., thickness, weight, material, etc.) of a page, a touch location in the page, and speed of a touch gesture.

The near field communication module 170 performs a function of connecting the portable terminal 100 to an external device in a wired or wireless manner. The near distance communication module may include a Zigbee module, a WiFi module, or a Bluetooth module. In particular, the near field communication module 170 may receive an e-book from the external device and transfer the received e-book to the memory 140.

The vibration motor 180 generates vibration under the control of the controller 190. Particularly, the vibration motor 180 provides vibration feedback associated with haptic. That is, the controller 190 provides feedback in which pages are turned by driving one or more vibration motors according to a motion of the touch gesture. The feedback by the vibration motor 180 may be changed according to attribute information (e.g., materials, thickness, weight, etc.) of the page.

The sensor 185 may detect at least one variations such as slop variation, luminance variation, or acceleration variation, and transfer a corresponding electric signal to the controller 190. The sensor 185 may detect state variation achieved based on the portable terminal 100, and generate and transfer a corresponding detection signal to the controller 190. The sensor 185 may be configured by various sensors. During driving of the portable terminal 100 (or based on user setting), power is supplied to at least one sensor set according to the control of the controller 190, so that state variation of the portable terminal 100 may be detected. According to an exemplary embodiment, the sensor 185 may always operate to detect state variation of the portable terminal 100, particularly, gradient variation. In the exemplary embodiment, the sensor 185 may be driven according to user setting or a manual operation of the user.

The sensor 185 may include at least one of various forms of sensing devices capable of detecting state variation of the portable terminal 100. For instance, the sensor 185 may include at least one of various sensing devices such as an acceleration Sensor, a gyro Sensor, a luminance sensor, a proximity sensor, a pressure sensor, a noise sensor (e.g., microphone), a video sensor (e.g., camera module), and a timer. The sensor 185 may be implemented by integrating a plurality of sensors (e.g., sensor 1, sensor 2, sensor 3, etc.) with one chip or a plurality of sensors may be implemented as separate chips. For example, the controller 190 may determine a current state according to gradient information (e.g., measured values with respect x axis, y axis, and z axis) detected by an operation sensor.

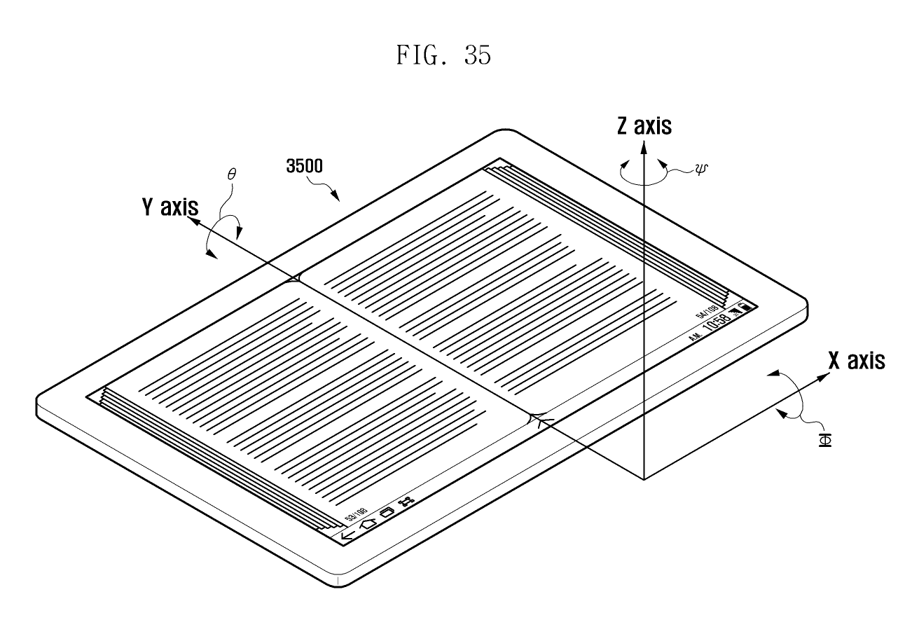

The sensor 185 may measure acceleration of the portable terminal 100 to generate an electric signal, and transfer the generated electric signal to the controller 190. For example, assuming that the sensor 185 is a three-axis acceleration sensor, it may measure gravity accelerations with respect to the X axis, the Y axis, and the Z axis displayed on FIG. 35. Particularly, the sensor 185 measures acceleration in which a motion acceleration and a gravity acceleration of the portable terminal 100 are added. However, when the portable terminal 100 does not move, the sensor 185 may measure only the gravity acceleration. For example, the following description will be made on the assumption that a front surface of the portable terminal 100 orienting upwards is a positive (+) direction of the gravity acceleration and a rear surface of the portable terminal 100 orienting upwards is a negative (−) direction of the gravity acceleration.

As shown in FIG. 35, when a rear surface portion of the portable terminal makes contact with and is placed on a horizontal surface, X axis and Y axis components of gravity acceleration measured by the sensor 185 are 0 m/sec² and only a Z axis component is a specific amount (e.g., +9.8 m/sec²). In contrast, when a front surface portion of the portable terminal makes contact with and is put on a horizontal surface, X axis and Y axis components of gravity acceleration measured by the sensor 185 are 0 m/sec² and only a Z axis component is a specific negative amount (e.g., −9.8 m/sec²).

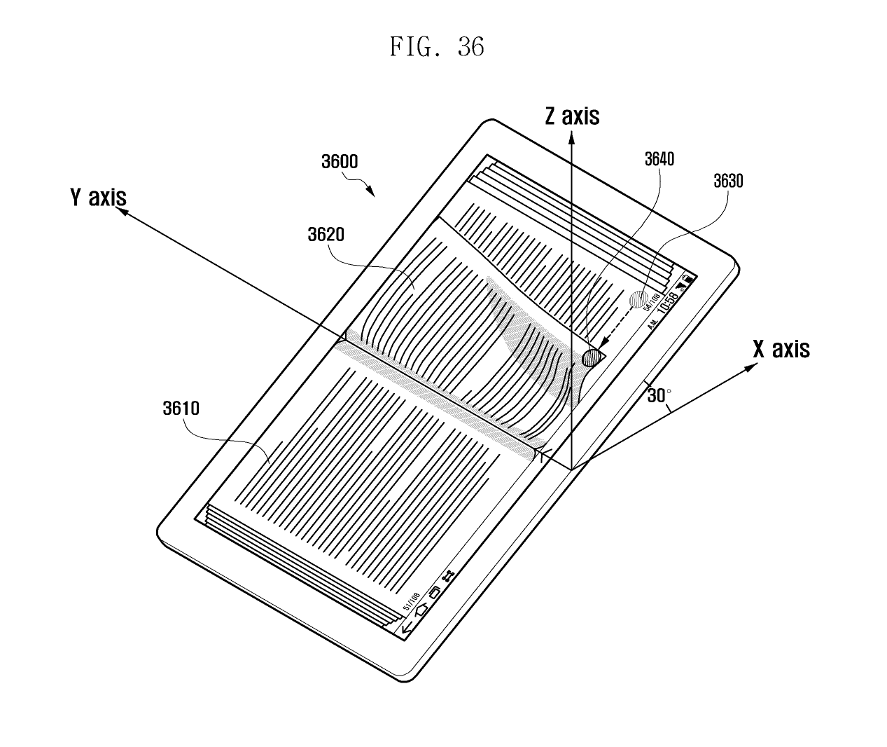

As shown in FIG. 36, when a user lifts the portable terminal 100 so that the portable terminal is positioned obliquely, at least one axis in the gravity acceleration measured by the sensor 185 is not 0 m/sec², and a square root of a sum of a square of three axis components, namely, a vector sum may become a specific value (e.g., 9.8 m/sec²). The sensor 185 detects accelerations with respect to X axis, Y axis, and Z axis directions, respectively. According to a coupling location of the sensor 185, respective axes and corresponding gravity accelerations may be changed.

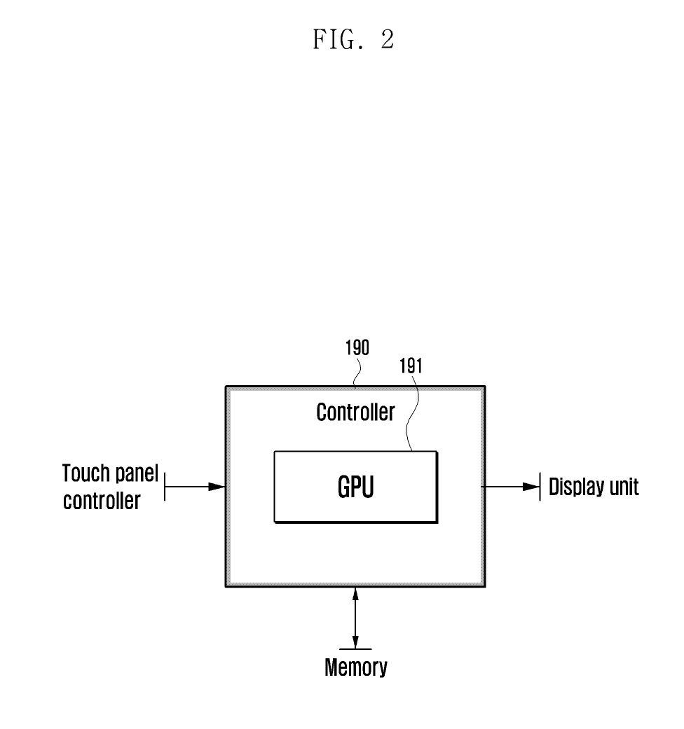

The controller 190 performs controls overall operations of the portable terminal 100 and signal flow between internal constituent elements of the portable terminal 100, and processes data. The controller 190 controls power supply from a battery to internal constituent elements. The controller 190 executes various applications stored in the program area. The controller 190 transforms a page in response to a touch gesture and gradient information of the portable terminal. To do this, the controller 190 may include a GPU as shown in FIG. 2.

FIG. 2 is a block diagram illustrating a configuration of a controller according to an exemplary embodiment. The controller 190 according to the exemplary embodiment may include a GPU 191. Referring to FIG. 2, the GPU 191 may perform a function of changing a page mesh in response to a touch gesture and reflects the transformed page mesh to generate an animation. In detail, the GPU 191 receives information associated with a touch gesture from the touch panel controller 130. The GPU 191 transforms the page mesh based on the received information. If a user gesture (e.g., touch input) is applied to a page, the GPU 191 transforms a page mesh in response to the user gesture. When the user gesture disappears from the page, for example, when the user drags and releases touching of the page or presses the page and then releases the page, the GPU 191 restores the page mesh to an original state. That is, the transformed page mesh is restored to an original state based on elastic characteristic of links and a gravity applied to respective nodes. The GPU 191 receives pages from the memory 140. The GPU 191 reflects transformation information of the page mesh to a page received from the memory 140 to generate an animation. The transformation information of the page mesh includes coordinate values (x, y, z) of respective nodes configuring the page mesh. The GPU 191 controls the display unit 112 to display the animation.

When the gravity acceleration transferred from the sensor 185 is measured by at least one axis component, the controller 190 may calculate a gradient of the portable terminal 100 using accelerations with respect to respective axes. Here, the calculated gradient may include a roll angle φ, a pitch angle θ, and a yaw angle ψ. The roll angle φ indicates a rotating angle based on an X axis in FIG. 35, the pitch angle θ indicates a rotating angle based on a Y axis in FIG. 35, and a yaw angle ψ indicates a rotating angle based on a Z axis in FIG. 35. In an exemplary case of FIG. 35, X axis and Y axis gravity accelerations in a gravity acceleration transfers from the sensor 185 are 0 m/sec² and a Z axis gravity acceleration is +9.8 m/sec², a gradient (φ, θ, ψ) of the portable terminal 100 may be (0, 0, 0). A certain gradient of the portable terminal 100 may be computed by the foregoing scheme. The controller 190 may compute the gradient of the portable terminal 100 through an algorithm such as a pose calculation algorithm using Euler angles, a pose calculation algorithm using an extended Kalman filter, or an acceleration estimation switching algorithm. That is, in the exemplary embodiment, a method of measuring a gradient of the portable terminal 100 using an accelerometer may be implemented using various schemes.

The GPU 191 may perform a function of transforming a page mesh in response to gradient variation of the portable terminal 100, and reflecting the transformed page mesh to a page to generate an animation. The GPU 191 receives gradient information of the portable terminal 100 from the controller 190. The GPU 191 computes a transformed degree of a page based on the received information, and generates and displays an animation corresponding to the computation result. For example, when a gradient (φ, θ, ψ) of the portable terminal 100 is (0, 0, 60), a display mode is a transverse mode displaying two pages in left and right sides of the screen, and a residual amount of the page put on a right side of the screen is 200 pages, the GPU 191 may generate and display an animation in which 100 pages are turned to a left side. A page turning mode may include a normal mode, a gradient mode, and a merge mode. The page turning mode may be set by the user. When the user selects a normal mode, the GPU 191 generates an animation in response to the detected touch gesture. When the user selects the gradient mode, the GPU 191 generates the animation using only a computed gradient information. When the user selects the merge mode, the GPU 191 generates in consideration of both of the touch gesture and the gradient information. Attribute information (e.g., thickness, weight, material, etc.) set in a page in respective modes may be considered in transforming the page. The attribute information may not be considered in transforming the page. The animation may be generated by the GPU 191 or an application processor (AP). The animation may be generated by both of the GPU 191 and the AP. The AP is configured by a CPU and a GPU as a system on chip (SoC). The AP is configured by packaging the CPU and the GPU with a multi-layer structure.

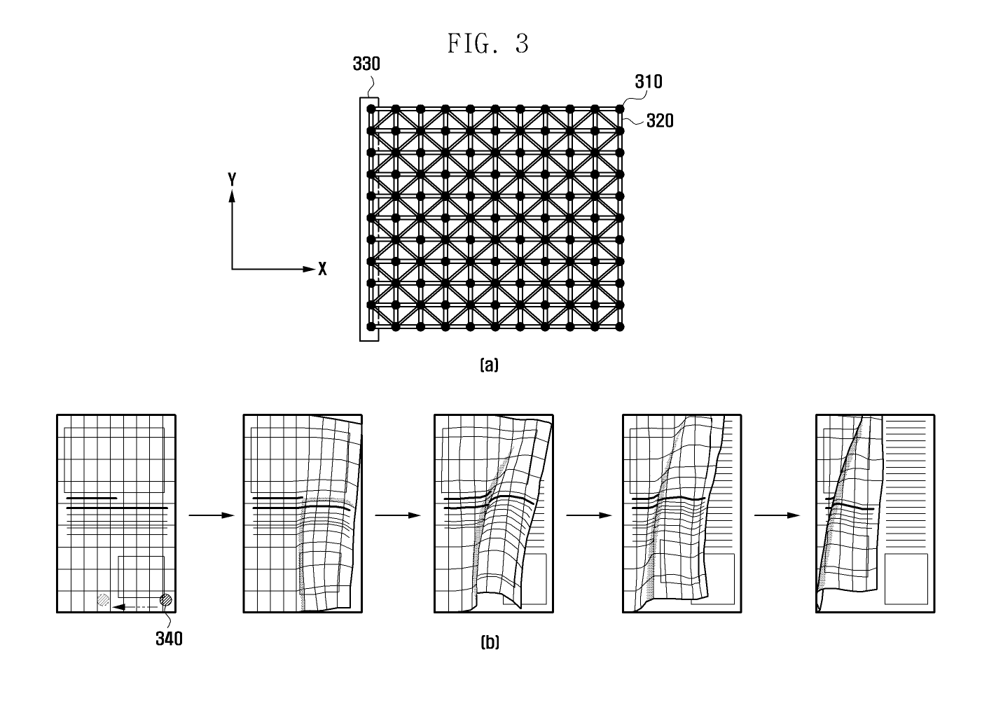

FIGS. 3A and 3B are diagrams illustrating a page mesh according to an exemplary embodiment. Referring to FIG. 3A, a controller 190, particularly, a GPU 191 configures a page mesh. The page mesh includes a plurality of nodes and a plurality links connecting the nodes to each other. In drawings, reference numeral 310 represents a plurality nodes, and reference numeral 320 represents a plurality of links. As shown, the nodes may be arranged in a matrix pattern, and locations thereof may be indicated by XY coordinates. As described above, a suitable weight value is allocated to respective nodes and a suitable elastic value is allocated to respective links (springs). A great weight value may be allocated to nodes located in the center 330 of an e-book. A weight value less than that of the center 330 may be allocated to nodes located an outer side relatively away from the center 330. Then, the motion of a node located in an outer side is light. The node located in the outer side sensitively reacts with a touch gesture of the user. As the page is turned, nodes located in a central axis (X axis) 330 are fixed unlike other nodes. The same weight value may be allocated to all the nodes. The motion of the page mesh may be collectively heavy as compared with a previous case. That is, a transformed degree of the page may be changed according to attribute information (e.g., thickness, weight, material, etc.) set in a corresponding page. The transformed degree of the page may be changed according to the computed gradient.

When human power a user input, such as, a touch gesture is applied to the displayed page, the controller 190, particularly, the GPU 191 detects a touch gesture, transforms a page mesh in response to the detected touch gesture, and reflects the transformed page mesh to the page to generate an animation of the page being turned. In detail, referring to FIG. 3B, the user touches a right lower point 340 of a page using a touch input unit (e.g., finger, pen, etc.). Then, the GPU 191 detects a node which the touch input unit touches. After that, the user moves the touch input unit from the right lower point 340 in a left direction. Then, the GPU 191 moves a touched node (hereinafter referred to as ‘target node’ for convenience of a description) to the left direction on an XY plane according to the motion of the touch input unit. That is, the target node moves a direction perpendicular to a direction of gravity. The GPU 191 calculates displacement of a moved target node. The displacement is a vector value having a size and a direction. The size of the displacement includes at least one of a current location of the target node, a moving distance of the target node, and speed of the target node. For example, the size of the displacement may include only a current location of the target node, only a moving distance of the target node, and a combination of the moving distance of the target node and the speed of the target node. The controller 190 may transform a page mesh according to the computed displacement and reflect the transformed page to a page to generate animation.

The GPU 191 calculates powers applied to respective nodes using the calculated displacement. The power is a vector value having a size and a direction. In an embodiment, the power is a sum of elastic power, gravity, and virtual human power associated with a user gesture (e.g., speed and/or moving distance of touch input). When the page turning mode is set to a gradient mode or a merge mode, the power may further include a gradient of the portable terminal. The GPU 191 calculates locations of the nodes using the calculated powers. The GPU 191 generates an animation as illustrated in FIG. 3(b) using the calculated locations. The GPU 191 may move the target node (namely, a node which the human power is directly applied) to a direction perpendicular to gravity. That is, as an X axis value and a Y axis value of the target node are changed, a Z axis value is changed or ‘0’. The GPU 191 fixes a node located in a central axis 230 unlike other nodes. This is the same as that the user pushes actually and moves a page of a paper book. Accordingly, as shown in FIG. 3B, the transformed page is expressed in a convex form. As described above, as illustrated with reference to FIGS. 3A and 3B, the page mesh may be actually and variously transformed according to a touch point, a motion direction of a touch, and a speed of the touch. Accordingly, the user may experience an actual feeling of a paper book through an e-book.

The constituent elements can be variously changed according to convergence trend of a digital device. The portable terminal 100 according to the exemplary embodiment may further include constituent elements which are not mentioned such as a GPS module and a camera module. The portable terminal 100 of the exemplary embodiment may be substituted by specific constructions in the foregoing arrangements according to the provision form.

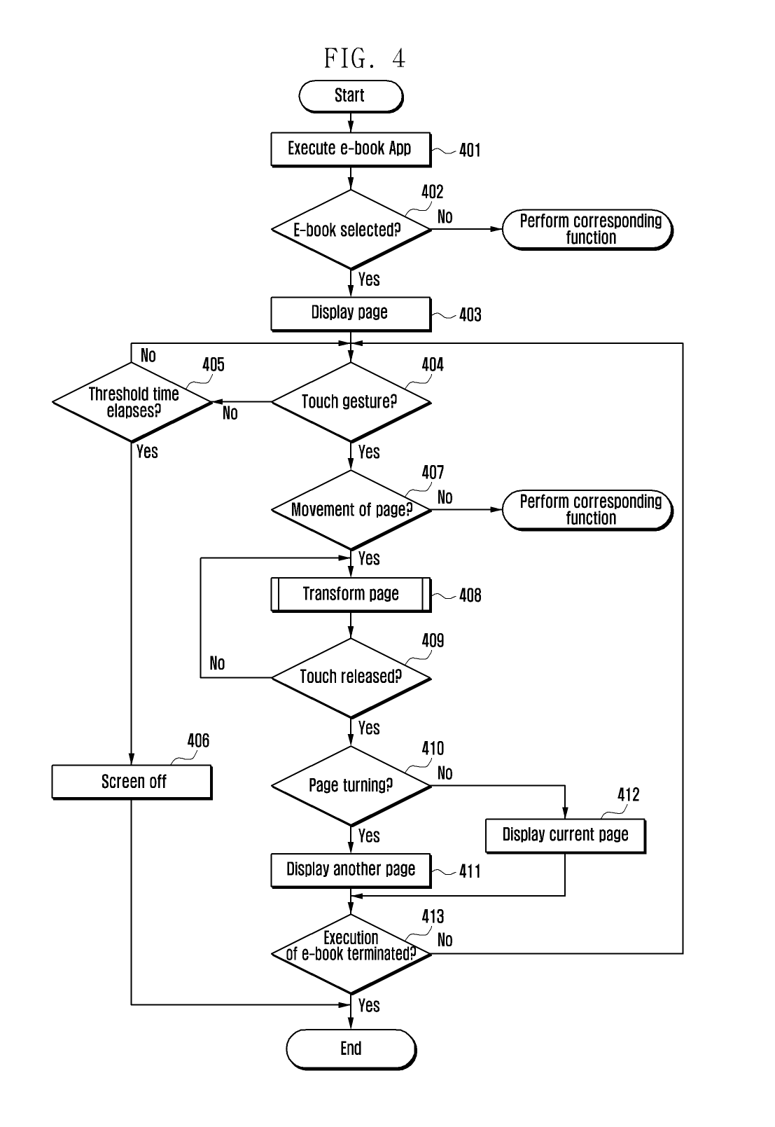

FIG. 4 is a flowchart illustrating a method of displaying a page according to an exemplary embodiment. It is assumed that a page turning mode is a standard mode. Referring to FIG. 4, a controller 190 may firstly be in an idle state. For example, the controller 190 displays a home screen including an icon for executing an e-book App. The controller 190 may detect a touch associated with an execution request of the electronic book App. If the execution request of the e-book App is detected, the controller 190 may execute the e-book App and control such a bookmark screen is displayed (401). The controller 190 may detect a user gesture selecting an icon of one of a plurality of e-books while displaying a bookmark screen (402). If selection of the e-book is detected, the controller 190 controls so that a page of the selected e-book is read from a database and is displayed (403). When the e-book is initially open, a list or a first page of e-book may be displayed. When the e-book is previously viewed, a last stored page may be displayed. If a touch gesture associated with an execution request of a function other than selection of the e-book, for example, a bookmark edit function is detected, a corresponding function is performed.

While the page of the e-book is being displayed, the controller 190 may determines whether a touch gesture is detected (404). When the touch gesture is not detected at operation 404, the process goes to operation 405. The controller 190 determines whether a threshold time elapses (405). The threshold time is a value set to automatically turn-off a screen. For example, when no touch event is detected before the threshold time elapses, the controller 190 turns-off a screen (406). The threshold time may be set to 30 seconds and be changed by the user. Meanwhile, the process may be terminated without performing operation 406.

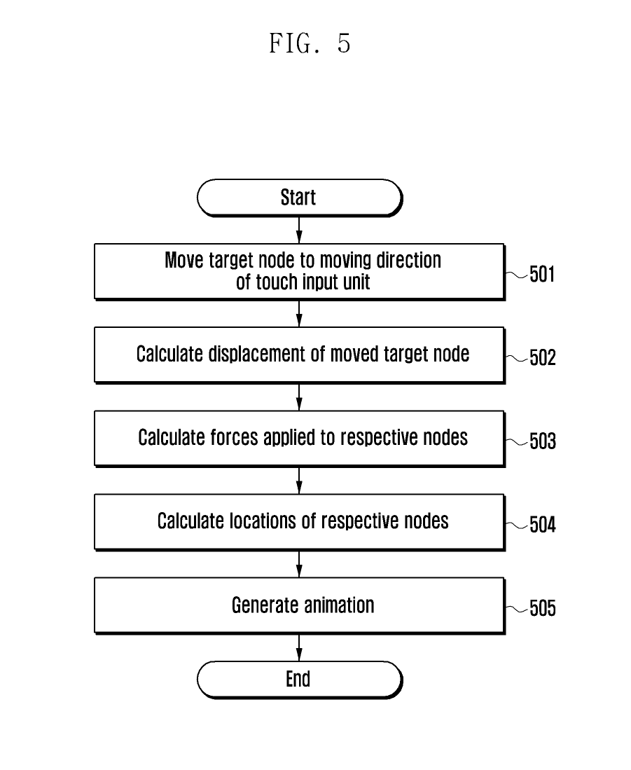

The controller 190 may detect the touch gesture from the touch screen 110 while the page of the e-book is being displayed (404). When the touch gesture is detected, the controller 180 determines whether the detected touch gesture is associated with movement of the page such as a drag or a flick (407). When the detected touch gesture is not associated with the movement of the page, for example, is associated with a display request of a bookmark screen, the controller 190 performs a corresponding function. When the detected touch gesture is associated with the movement of the page, the controller 190 transforms a corresponding page (408). The controller 190 transforms a page mesh in response to the touch gesture and reflects the transformed page mesh onto the page to generate the animation (408). A detailed procedure of operation 408 will be described with reference to FIG. 5.

After transforming the page, the controller 190 determines whether a touch is released (409). When the touch is not released but is maintained, the process returns to operation 408. Conversely, if the touch is released, the process goes to operation 410. The controller 190 determines whether the touch release corresponds to page turning (410). That is, the controller 190 may determine whether the page is turned based on at least one of a direction, a location, and speed of the touch gesture before the touch is released. When the page is turned, the controller 190 turns a current displayed page and controls such that another page is displayed (411). When the touch release does not correspond to page turning, the controller 190 maintains display of a current page (412). The controller 190 determines whether execution of the e-book is terminated (413). When the execution of the e-book is not terminated, the process returns to operation 404.

FIG. 5 is a flowchart illustrating a method of transforming a page according to an exemplary embodiment. Referring to FIG. 5, a controller 190 detects a node touched by a touch input unit, that is, a target node. Further, the controller 190 detects a moving direction of the touch input unit. The controller 190 moves the target node to the moving direction of the touch input unit (501). Particularly, the controller 190 may move the target node to a direction perpendicular to a gravity direction. The controller 190 may move the target node to a determined gradient (e.g., −30°˜+30°) based on the gravity direction. Next, the controller 190 calculates a displacement of the moved target node (502). The displacement has a size and a direction as a vector value. A size of the displacement includes at least one of a current location of the target node, a moving distance of the target node, and moving speed of the target node. For example, the size of displacement may include only the current location of the target node, only the moving distance of the target node, only the speed of the target node, or a combination of the current location of the target node, the moving distance of the target node, and the speed of the target node.

Next, the controller 190 calculates forces applied to respective nodes using the calculated displacement of the target node (503). The calculation of the forces is generally known in the art. That is, the controller 190 calculates magnitudes of the forces applied to the respective nodes and applied directions of the forces (503). After that, the controller 190 transforms a page mesh to be applied to respective nodes corresponding to the calculated forced (505). That is, the controller 190 calculates locations of respective nodes using the calculated forces (504). Finally, the controller 190 applies the transformed page mesh to the page to generate an animation (505). As described above, the target node is moved to a direction perpendicular to gravity or a direction of a determined gradient to convexly transform the page so that the animation is generated.

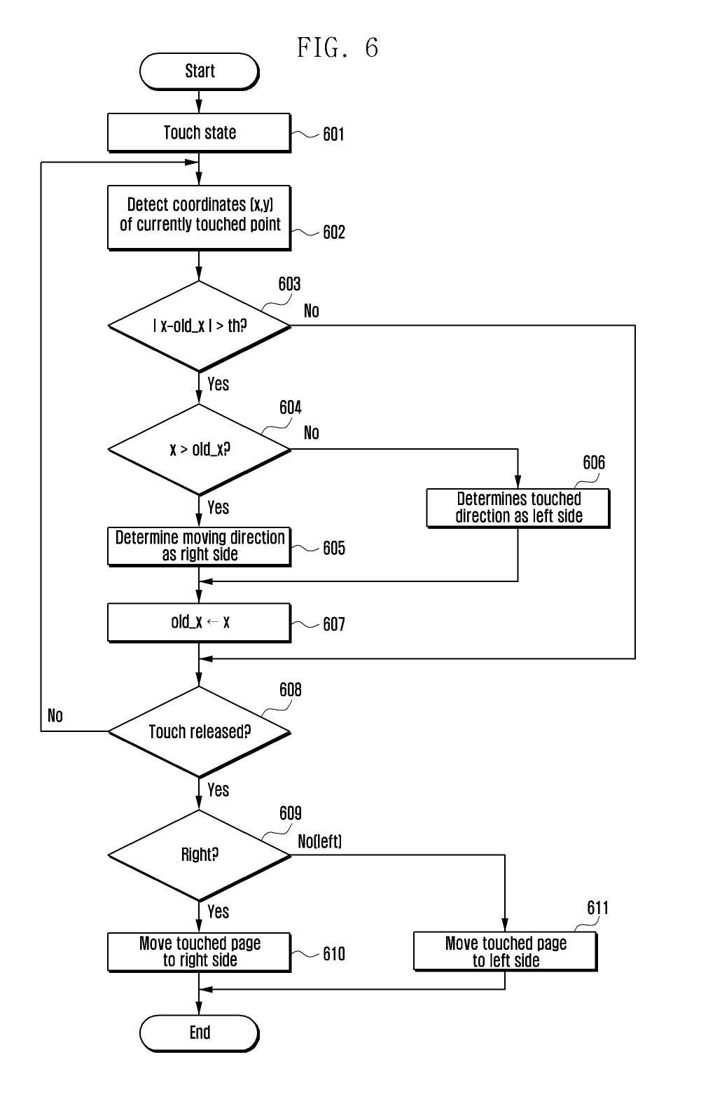

If the user removes (touch release) the touch input unit from the page, the page returns to an original state, that is, a spread state. In this case, the page may be turned or return to an original position without being turned. Such a result may be determined by forces applied to respective nodes of the page mesh. That is, if the human power (e.g., user gesture input) is removed, only an elastic force and gravity remain. The controller 190 computes a sum of forces applied to respective nodes of the page mesh. The controller 190 may determine the moving direction based on the sum of the forces. The controller 190 moves the page to the determined direction. For example, the page may be moved to a direction to which a gravity center of the page mesh heads. The moving direction of the page may be determined as a moving direction of the touch input unit just before the touch input unit is removed or released from the screen (that is, page). An example of this will be described with reference to FIG. 6.

FIG. 6 is a flowchart illustrating a method of turning pages according to an exemplary embodiment. Referring to FIG. 6, the display unit 120 displays a page and a touch input unit of a user is touching the displayed page (601). While the touch input unit is touching, the controller 190 detects coordinates (x,y) of a currently touched point (602). It is assumed that an X axis is a horizontal axis based on a viewpoint which the user views a screen. It is assumed that two pages are displayed at a left side and a right side based on a central line of a screen, respectively. Further, it is assumed that a right side is a positive direction of an X axis and a left side is a negative direction of a Y axis based on the central line. Under the assumption, the controller 190 determines whether “|x−old_x|>th” (603). The “x” means an x coordinate of a current touched point, the “old_x” means an x coordinate of a previously touched point, the “th” means a preset threshold value. For example, “th’ may be 5 mm. When |x−old_x|≦th, the process may goes to step 608. When “|x−old_x|>th”, that is, when a difference between the x coordinate of a currently touched point and the x coordinate of the previously touch point exceeds the threshold value, the process goes to operation 604.

The controller 190 determines whether the x coordinate of the currently touched point is greater than the x coordinate of the previously touched point (604). When the x coordinate of the currently touched point is greater than the x coordinate of the previously touched point, the controller 190 determines a moving direction of the touch input unit as a ‘right side’ (605). When the x coordinate of the currently touched point is less than the x coordinate of the previously touched point, the controller 190 determines a touched direction as a ‘left side’ (606). After the determination, the controller 190 sets the x coordinates of the currently touched point as an old_x of the previously touched point (607). The controller 190 determines whether a touch is released (608). If the touch is not released, the process may return to operation 602. Conversely, when the touch is released, the controller 190 determines whether the determined touched direction is a right side (609). When the touched direction is the right side, the controller 190 moves the touched page to the right side (610). If the touched page is a left page, operation 610 corresponds to an operation of turning the page to a previous page. Conversely, if the touched page is a right page, operation 610 corresponds to an operation of maintaining display of the touched page without turning the page to a next page. When the touched direction is a left side, the controller 190 moves the touched page to a left side (611). Here, if the touched page is the left page, operation 611 corresponding to an operation of maintaining display of the touched page without turning the page back. Conversely, if the touched page is the right page, operation 611 corresponds to an operation of turning the page back.

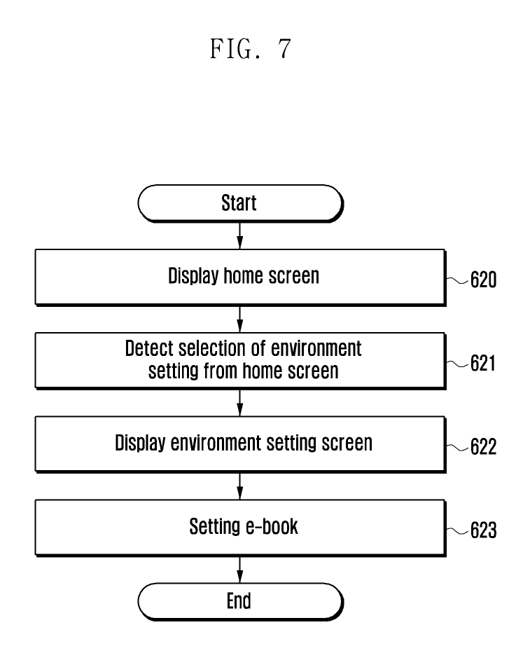

FIG. 7 is a flowchart illustrating a method of describing setting an electronic book according to an exemplary embodiment. Referring to FIG. 7, a controller 190 may control a display unit 112 to display a home screen (620). The home screen includes an icon corresponding to environment setting. The user may select an icon corresponding to the environment setting. The controller 190 detects selection of a user with respect to an icon corresponding to the environment setting from the home screen (621). The controller 190 controls the display unit 112 to display an environment setting screen of the portable terminal 100 (622). The controller 190 may set environments of the portable terminal, for example, environments with respect to the e-book according to a user operation for the touch screen 110 (623). Preset values associated with the e-book are stored in the memory 140 of the portable terminal. The preset information stored in the memory 140 may be used when the e-book App 142 is executed.

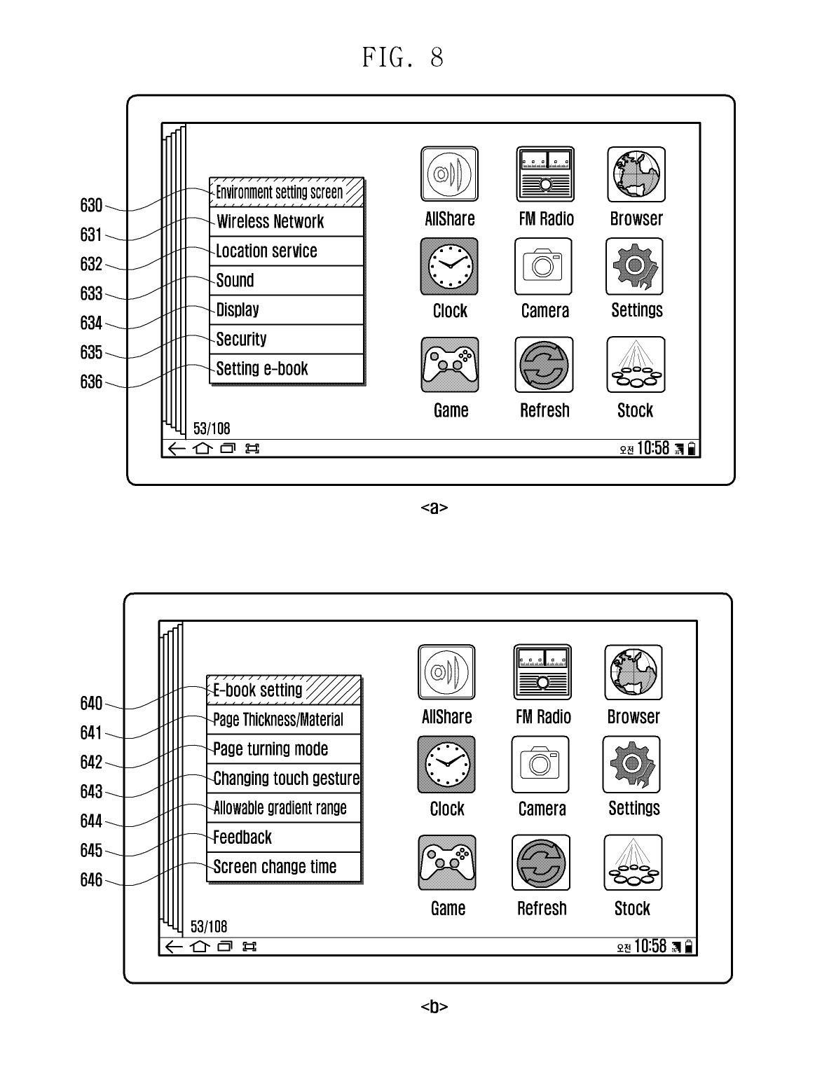

FIG. 8A is an exemplary diagram illustrating a screen for setting environments of the portable terminal. Referring to FIG. 8A, the display unit 112 may display an environment setting screen 630 under control of the controller 190. The displayed environment setting screen 630 may include a wireless network 631, a location service 632, a sound 633, a display 634, a security 635, and setting an e-book 636. The user may touch the setting the e-book 636 from the items. Then, the controller 190 may control the display unit 112 to display the e-book setting screen for setting environments of the e-book.

FIG. 8B is an exemplary diagram illustrating a screen for setting environments of the electronic book. Referring to FIG. 8B, the display unit 112 may display the e-book setting screen 640 under control of the controller 190. The displayed e-book setting screen 640 may include items such as a thickness/material 641, a page turning mode 642, changing a touch gesture 643, an allowable gradient range 644, a feedback 645, and a screen change time 646. As listed in the table 1, the page thickness/material 641 may be 75 g/m² and a printing page. The page thickness/material 641 is set by a manufacturing company of an e-book and cannot be changed by the user. The page turning mode 642 is an item capable of selecting one of a normal mode, a gradient mode, and a merge mode. When the user selects the normal mode, the GPU 191 generates an animation in response to the detected touch gesture. When the user selects the gradient mode, the GPU 191 generates the animation in consideration of only computed gradient information. When the user selects the merge mode, the GPU 191 generates the animation in consideration of both of the touch gesture and the gradient information. The changing the touch gesture 643 is an item changing a touch gesture allowed turning the page. For example, the touch gesture for paging turning may be changed from flick to drag and vice versa. An allowable gradient range 644 in which the target node may be moved may be in the range of −30°˜+30°. The feedback 645 is an item for determining feedback to be provided to the user when the page is turned. For example, the user may be provided with vibration and an effect sound as the feedback. For example, the screen change time 646 may be set to 0.5 second. Hereinafter, the exemplary embodiment will be described in detail with reference to exemplary diagrams of a screen. Prior to the description, in the exemplary embodiment, a display mode of the screen is divided into a landscape mode and a portrait mode. When the current display mode is the landscape mode, the portable terminal 100 displays two pages in left and right sides. However, the exemplary embodiment is not limited thereto. If the user rotates the portable terminal 100, the sensor 185 of the portable terminal 100 detects the rotated portable terminal and transfers detection information to the controller 170. The controller 170 may determines a display mode of the portable terminal 100 based on the detection information. All types of display modes are applicable to the present invention.

FIGS. 9 to 33 are exemplary diagrams illustrating screens for describing a method of displaying a page according to an exemplary embodiment. It is assumed that the page turning mode is the normal mode. As described above, the controller 190 may move a target node to convexly transform the page. Even if a shape of the page is convex, a concrete form of the page may be change according to touch information (e.g., touched location, moving direction, moving distance, speed, etc.).

Referring to FIG. 9, the user may touch the screen with the touch input unit at right lower corner 710 of a right page. Then, the controller 190 detects a target node corresponding to the right lower corner 710. The user may move the touch input unit to a left lower side in a touched state of the right bottom corner 710. Then, the controller 190 moves the target node towards the left lower corner. The controller 190 calculates a displacement of a moved target node. In detail, the controller 190 calculates a current location of the target node, moving speed of the target node, and a moving direction of the target node. Next, the controller 190 calculates forces applied to respective nodes using the calculated displacement. Subsequently, the controller 190 calculates locations of the respective nodes using the calculated forces. After that, the controller 190 generates the animation using the calculated locations. The controller 190 controls the display unit 112 to display the generated animation. FIG. 9 illustrates an animation (that is, transformed form of page) when the touch input unit is moved from the right lower corner 710 towards the left lower corner and is located in a first lower side point 720. As shown, the page is large transformed to a moving direction (710->720) of the target node and is convex. A corner region 715 having a target node is compared with another corner region and is closet to a spine.

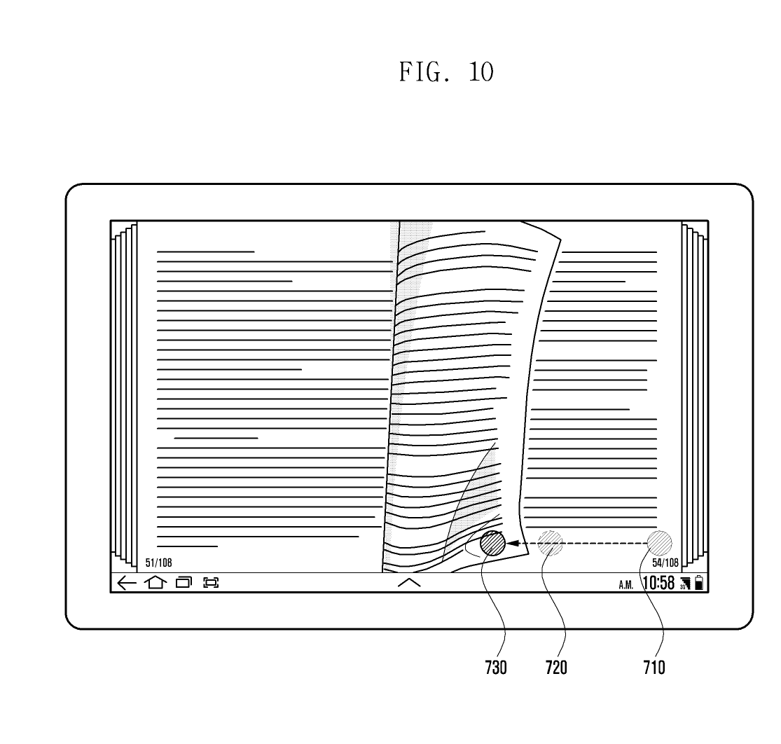

Referring to FIG. 10, the user may move the touch input unit from a first lower side point 720 to a left lower corner. Then, the controller 190, that is, the GPU 191, generates the animation and controls the display unit 112 to display the generated animation. That is, FIG. 10 illustrates the animation when the touch input unit is located at the second lower side point 730. Comparing FIG. 10 with FIG. 9, a page of FIG. 10 has a convex shape and the page of FIG. 10 is convex as comparison with the page of FIG. 9. Accordingly, if the user releases the touch, the page of FIG. 9 is not turned but the page of FIG. 10 may be turned. In a case of FIG. 9, if the user releases a touch from the first lower side point 720, a direction of a force (that is, weight center of the page) may be applied to a right side. Accordingly, the page returns to the original place without being turned. In a case of FIG. 10, if the user releases a touch in the second lower point 730, a direction of a force may be applied to a left side. Accordingly, the page may be turned to an opposite side. As a result, a direction of a weight center of the page may be associated with a current touched point. There may be a turning condition in a case of FIG. 9. An example of the condition is described in detail with reference to FIG. 6. The page turning may be determined according to speed which the touch input unit moves from the lower right corner 710 to the first lower point 720. For example, if the touch input unit is moved at speed of 30 cm/sec and then touch-released, the page may be turned. When the speed is greater than 30 cm/sec, the page may not be turned. Determination of the page turning using the speed is equally applicable to following examples.

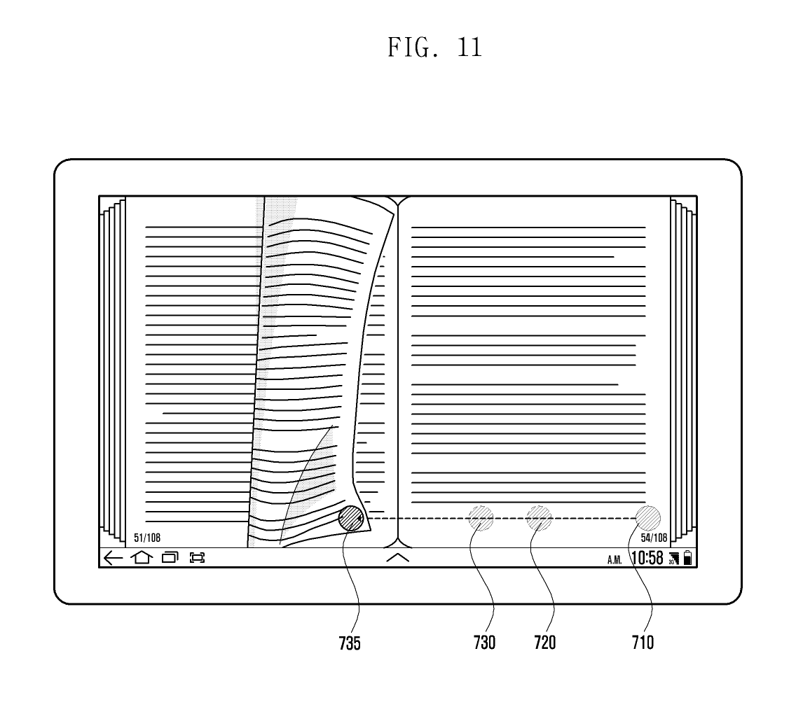

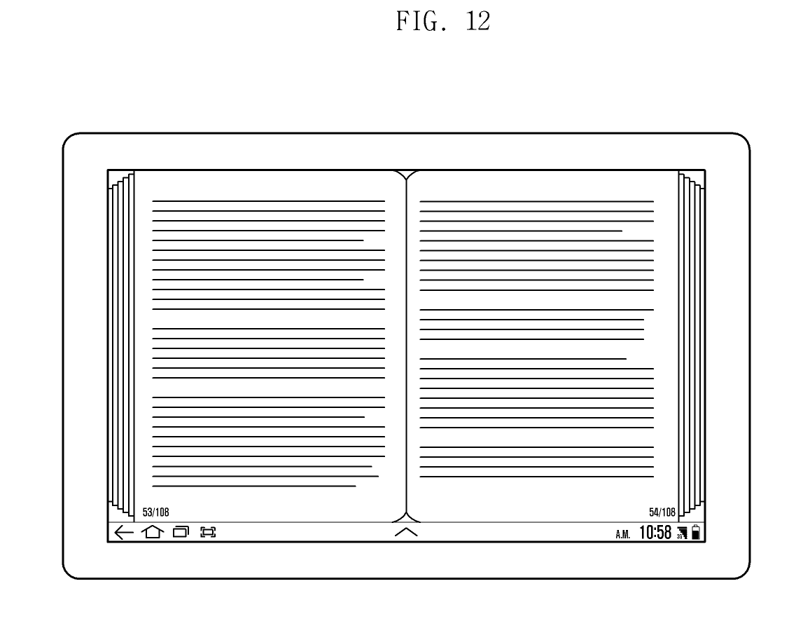

Referring to FIGS. 10 and 11, the user may move the touch input unit from the second lower point 730 to a left side in a continuously maintained state of the touch. That is, the user may locate the touch input unit in a first left point 735 beyond a central line separating a left page and a right page. As shown in FIG. 11, the controller 190 may control such that a rear surface (e.g., page 53) of the page may be partially displayed. If the user releases the touch from the first left point 735, as shown in FIG. 12, the controller 190 may display an entire rear surfaced at a left side. If the touch input unit is moved from the left side to the right side through the central line, the rear surface of the page may be displayed. If the touch is released beyond the central line, the page may be turned. Although the touch input unit does not cross the central line, a rear surface of a currently operated page may be displayed. For example, if the touch input unit approaches the central line within a preset threshold (for example, within 10 mm from the central line), the controller 190 may control the display unit 112 to display the rear surface. The threshold for displaying the rear surface may be changed to a value other than 10 mm. Hereinafter, exemplary diagrams of other screen will be described. However, the description with respect to repeated parts of FIGS. 9 to 12 is omitted.

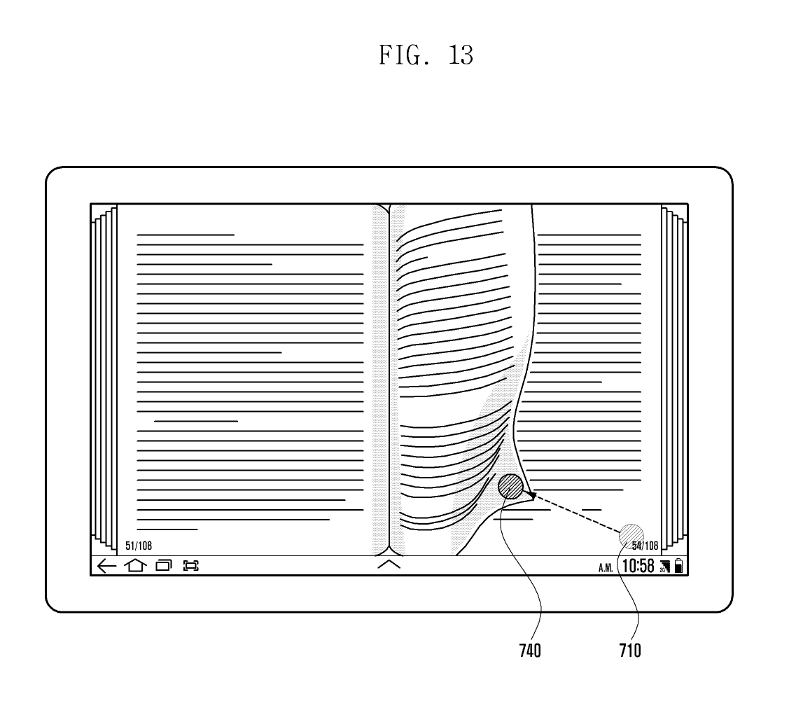

Referring to FIG. 13, the user may touch the touch input unit in a right lower point 710 of a page and then move the touch input unit from the right lower point 710 towards a left upper corner. Then, the controller 190 generates an animation and controls the display unit 112 to display the generated animation. That is, FIG. 13 illustrates an animation when the touch input unit is moved from the right corner 710 towards the left upper corner and is located at the third lower point 740. Comparing FIG. 13 with FIG. 9, the touch input unit in FIGS. 9 and 13 starts from the same right lower point but moving directions thereof are different from each other. Accordingly, it is understood that shapes of the transformed page in FIGS. 9 and 13 are different from each other. When the user releases the touch, the page in FIG. 9 may not be turned but the page in FIG. 13 may be turned to a left side. The touch in both of FIGS. 9 and 13 starts from a right lower corner of the page. However, the moving direction of FIG. 9 is towards an opposite lower corner, whereas the moving direction of FIG. 13 is towards a center of the page. Accordingly, in a case of FIG. 9, a weight center of a lower side of the page may be a left side and a weight center of an upper side of the page may be a right side. In this case, a total weight center may be the right side. Accordingly, the page is not turned. Meanwhile, in a case of FIG. 13, since a moving direction of the touch is not towards the corner but instead towards the center of the page, both of weight centers of upper/lower sides of the page may be the left side. Accordingly, the page is turned. As a result, a direction of the weight center of the page may be associated with a moving direction of the touch together with a current touched point and speed of the touch.

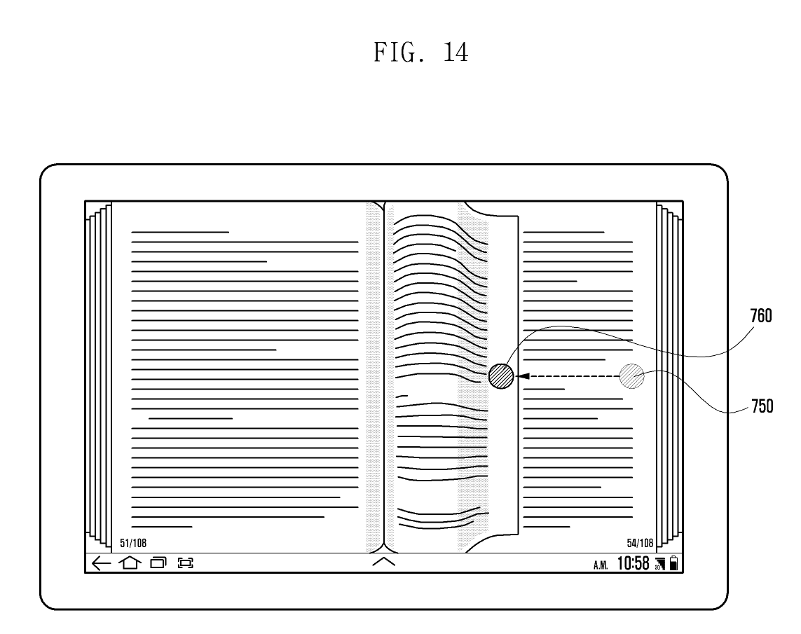

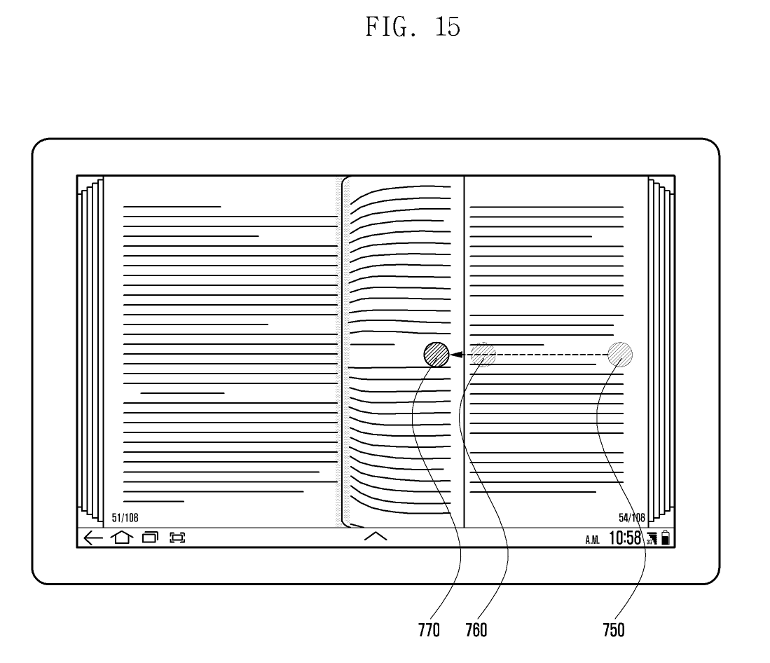

Referring to FIGS. 14 and 15, the user may touch the screen with the touch input unit at a right point 750 of a center of a page, and move the touch input unit towards an opposite side (left side). That is, FIG. 14 illustrates an animation when the touch input unit is moved from the right side towards the left side and is located at a central point 760. As shown in FIG. 14, if the user touches a right point 750 of the center of the page and then moves the touch input unit to a left side, upper and lower portions of the page may be uniformly and symmetrically transformed. Meanwhile, the user may move the touch input unit from the central point 760 towards the left side. That is, FIG. 15 illustrates an animation when the touch input unit is located at the first left point 770. Comparing FIG. 15 with FIG. 14, in the same manner as in comparison of FIG. 10 with FIG. 9, a total shape of the page is convex. It is appreciated that the page in FIG. 15 is more convex than the page in FIG. 14. Accordingly, if the user releases the touch, the page of FIG. 14 may not be turned but the page of FIG. 15 may be turned. Comparing FIG. 14 with FIG. 9, moving directions of the touch input unit in both of FIGS. 9 and 14 are towards a left side, but initial touched in FIGS. 9 and 14 are different from each other. Accordingly, it is appreciated that shapes of transformed pages in FIGS. 9 and 14 are different from each other.

Comparing FIG. 15 with FIG. 10, if the user releases the touch, the page of FIG. 10 is not turned but the page of FIG. 15 may be turned. In both of FIGS. 10 and 15, the touch starts from the leftmost side of the page. However, in detail, the touch starts from the center in FIG. 15, whereas the touch starts from a lower side of the center in FIG. 10. Accordingly, in a case of FIG. 15, weight centers of both of upper and lower portions of the page may be a left side. Accordingly, the page is turned. In a case of FIG. 10, a weight center of a lower portion of the page is the left side but a weight center of an upper portion of the page is the right side. In this case, a total weight center of the page may not be turned. As a result, a direction of the weight center of the page may be associated with an initial touched point as well as a current touched point and a moving direction of the touch.

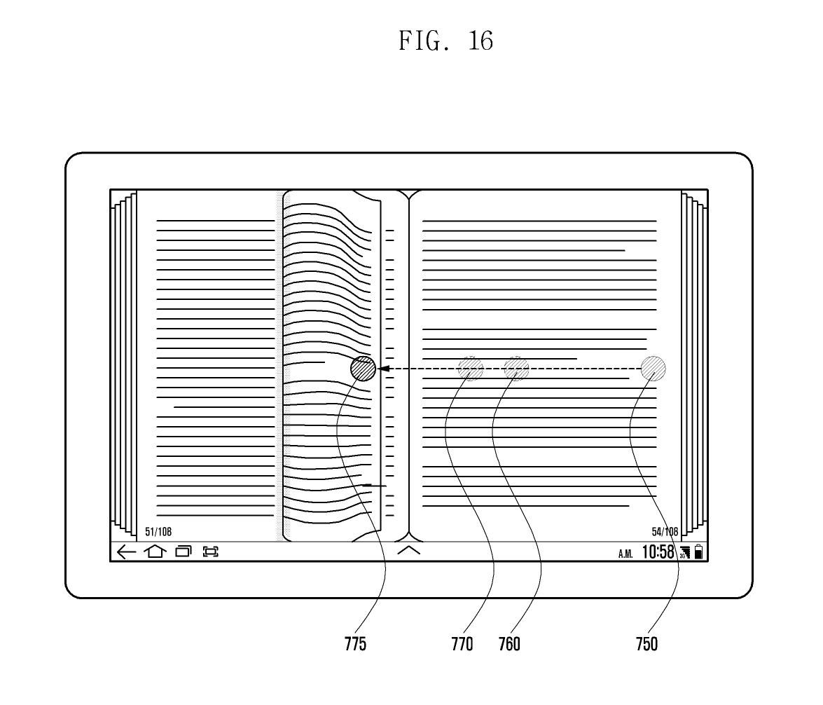

Referring to FIGS. 15 and 16, the user may move the touch input unit from the first left point 770 to the second left point 775 through a central line. Then, as shown in FIG. 16, the controller 190 may control the display unit 112 to display a part of a next page (e.g., page 53). If the user releases the touch from the second left point 775, the controller 190 may display an entire rear surface on a left side. Although the touch input mean does not pass through the central line, a rear surface of a current operated page may be displayed. For example, when the touch input unit approaches the central line within a preset threshold (e.g., 10 mm from the central line), the controller 190 may control the display unit 112 to display a rear surface.

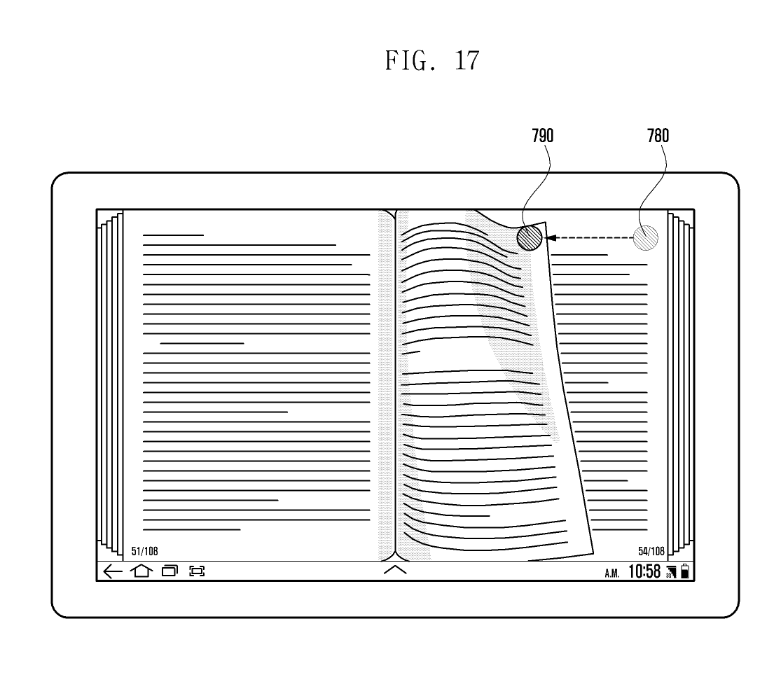

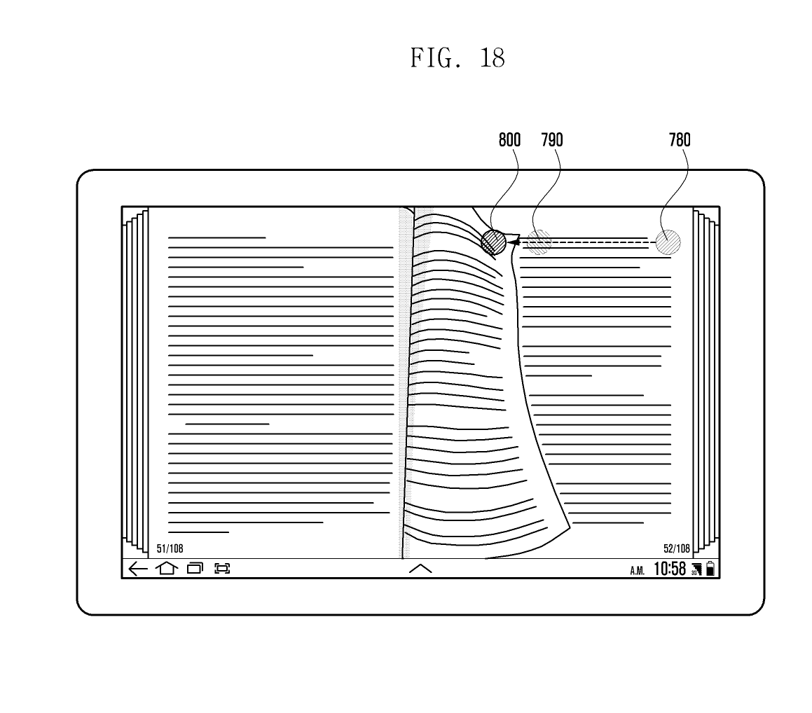

Referring to FIGS. 17 and 18, the user may touch the touch input unit at a right upper corner 780 and moves the touch input unit from the right upper corner 780 towards a left upper side. That is, FIG. 17 illustrates an animation when the touch input unit is moved from the right upper corner 780 towards a left upper corner, and is located in the first upper point 790. Meanwhile, the user may move the touch input unit from the first upper point 790 towards a right upper corner. That is, FIG. 18 illustrates an animation when the touch input unit is located at the second upper point 800.

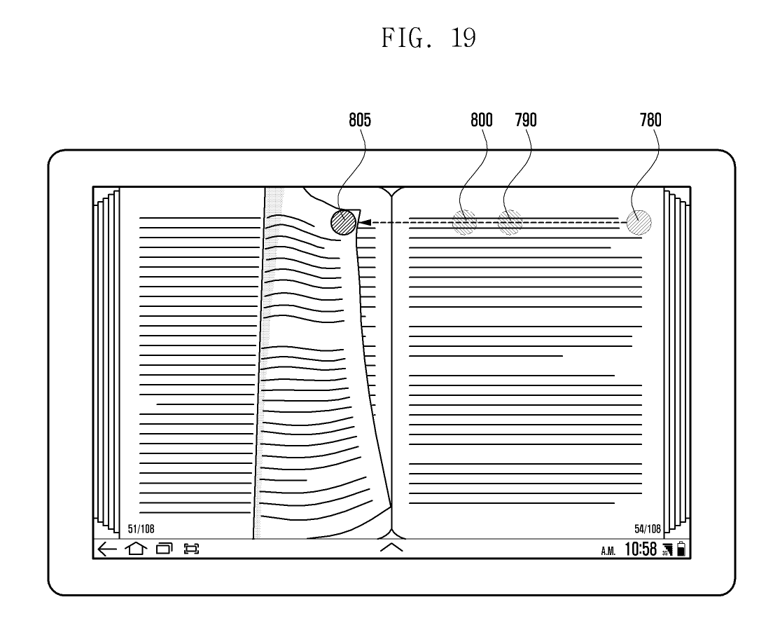

Referring to FIGS. 18 and 19, the user may move the touch input unit from the second upper point 800 to the third left point 805 through the central line. Then, as shown in FIG. 19, the controller 190 may control the display unit 112 to display a part of a next page (e.g., page 53). If the user releases the touch from the third left point 805, the controller 190 may display an entire rear surface to the left side. Although the touch input unit passes through the central line, a rear surface of a currently operated page may be displayed. For example, if the touch input unit approaches the central line within a preset threshold (e.g., 10 mm from the central line), the controller 190 may control the display unit 112 to display the rear surface.

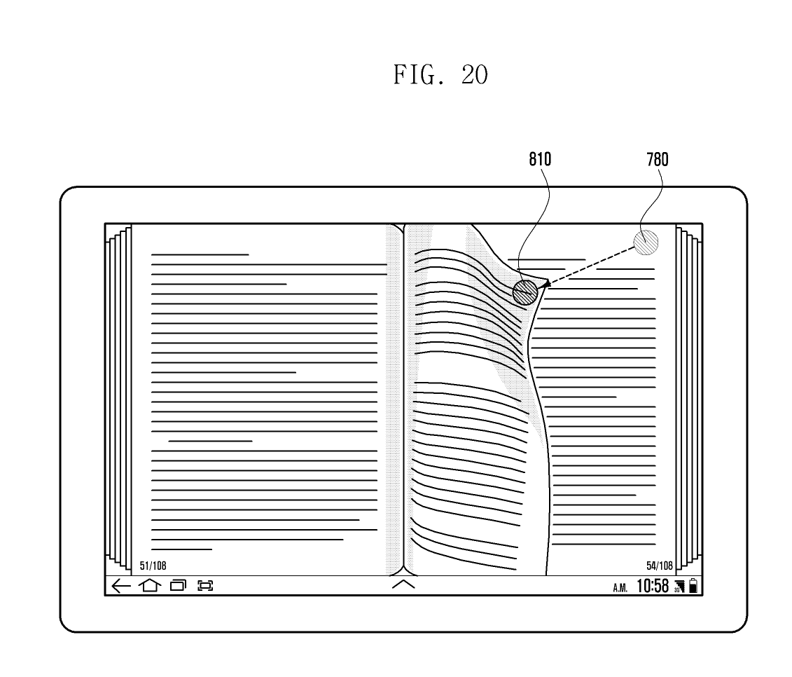

Referring to FIG. 20, the user may touch the touch input unit at a right upper corner 780 of a page, and then move the touch input unit from the right upper corner 780 towards a left lower corner. That is, FIG. 20 illustrates an animation when the touch input unit is moved from the right upper corner 780 towards the left lower corner and is located at the third upper point 810. Comparing FIG. 20 with FIG. 17, the touch input unit in FIGS. 17 and 20 starts from the same right upper corner but moving directions thereof are different from each other. Accordingly, shapes of transformed pages in FIGS. 17 and 20 may be different from each other.

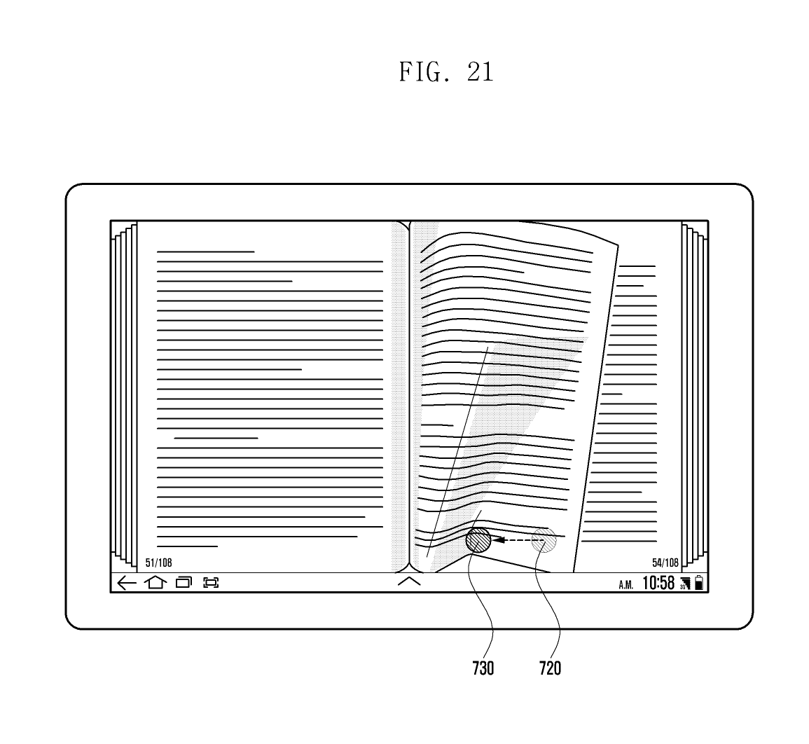

Referring to FIG. 21, the user may touch the touch input unit at a first lower point 720 of the page and then move the touch input unit from the first lower point 720 towards a left lower corner. That is, FIG. 21 illustrates an animation when the touch input unit is moved from the first lower point 720 towards the left lower corner and is located at the second lower point 730. Comparing FIG. 21 with FIG. 10, current touched points are the same as the second lower point 730. However, the first touched point is the right lower corner 710 in FIG. 10, whereas the first touched point is the first lower point 720 located at a left side of the right lower corner 710 in FIG. 21. That is, the current touched points are the same and the first touched points are different from each other. Accordingly, shapes of transformed pages in FIGS. 10 and 21 may be different from each other. If the user releases the touch, a page of FIG. 10 may be turned as described above. However, the page of FIG. 21 is not turned and may return to an original spread state. The reason is as follows. In a case of FIG. 10, a touch starts from a corner of the page. In a case of FIG. 21, the touch starts from the center of the page. That is, the first touched point of FIG. 21 differs from that of FIG. 10, and a moving distance of the touch in FIG. 21 is a relatively longer than that in FIG. 10. Accordingly, the controller 190 may determine whether the page is turned according to the first touched point and the moving distance of the page. That is, a direction of a weight center of the page may be associated with the moving distance of the touch as well as a current touched point, a moving direction of the touch, and the first touched point. Comparing FIG. 21 with FIG. 10, the touch starts from an corner of the page in a case of FIG. 10, and the touch starts from the center of the page in a case of FIG. 21. That is, in only a case where a larger force (e.g., speed) of the touch is applied as the first touched point is adjacent to a spine, the page may be turned.

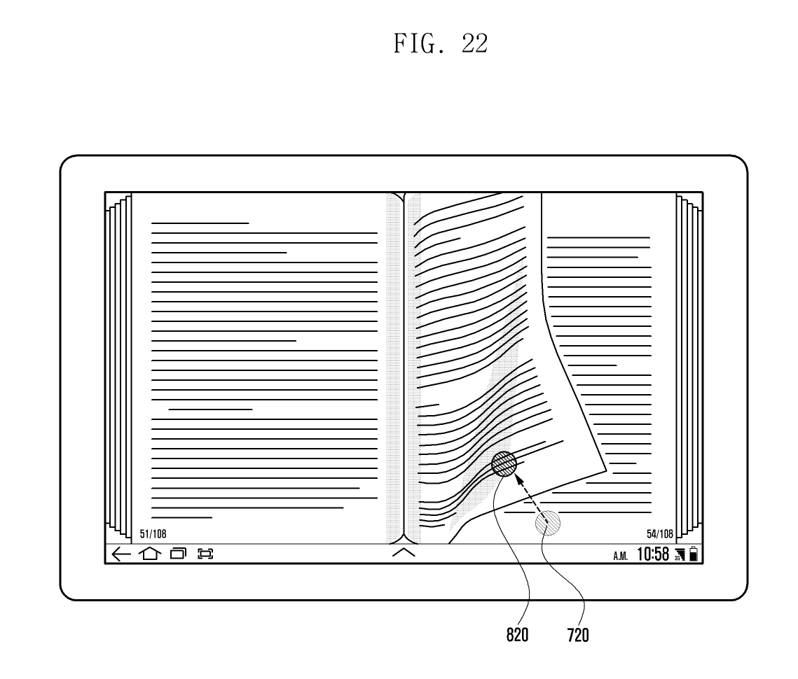

Referring to FIG. 22, the user may touch the touch input unit at the first lower point 720 of the page and move the touch input unit from the first lower point 720 to a left upper corner. That is, FIG. 22 illustrates an animation when the touch input unit is moved from the first upper point 720 to the left upper corner and is located at the fourth lower point 820. Comparing FIG. 22 with FIG. 21, the touch input unit in FIGS. 21 and 22 starts from the same first lower point but moving directions thereof are different from each other. Accordingly, shapes of transformed pages in FIGS. 21 and 22 may be different from each other.

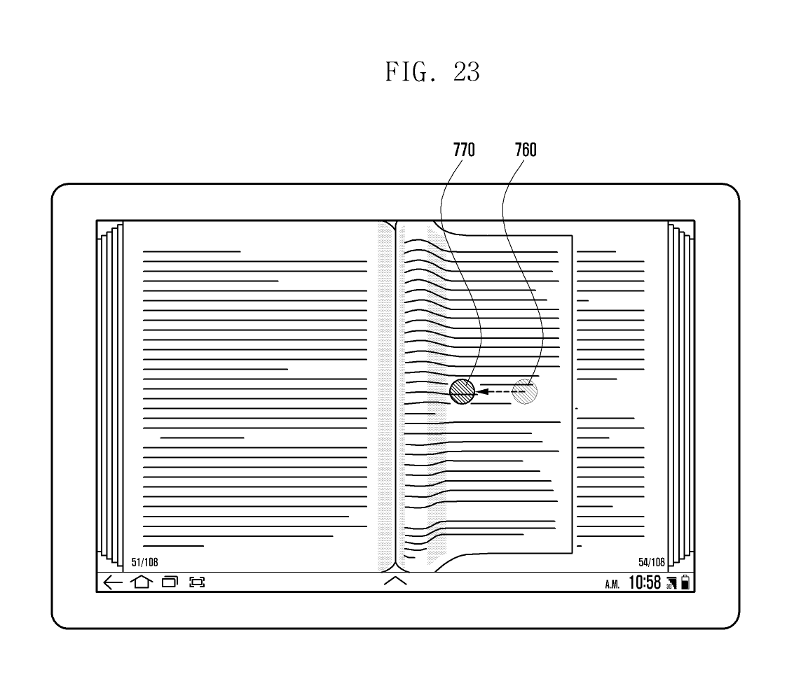

Referring to FIG. 23, the user may touch the touch input unit at a central point 760 and move the touch input unit from the central point 760 towards a left side. That is, FIG. 23 illustrates an animation when the touch input unit is moved from the central point 760 towards the left side and is located at the first left point 770. Comparing FIG. 23 with FIG. 15, since current touched points are the same which is the first left point 770 but first touched points are different from each other, shapes of transformed pages are different from each other. If the touch is released, the page of FIG. 15 may be turned but the page of FIG. 23 may not be turned.

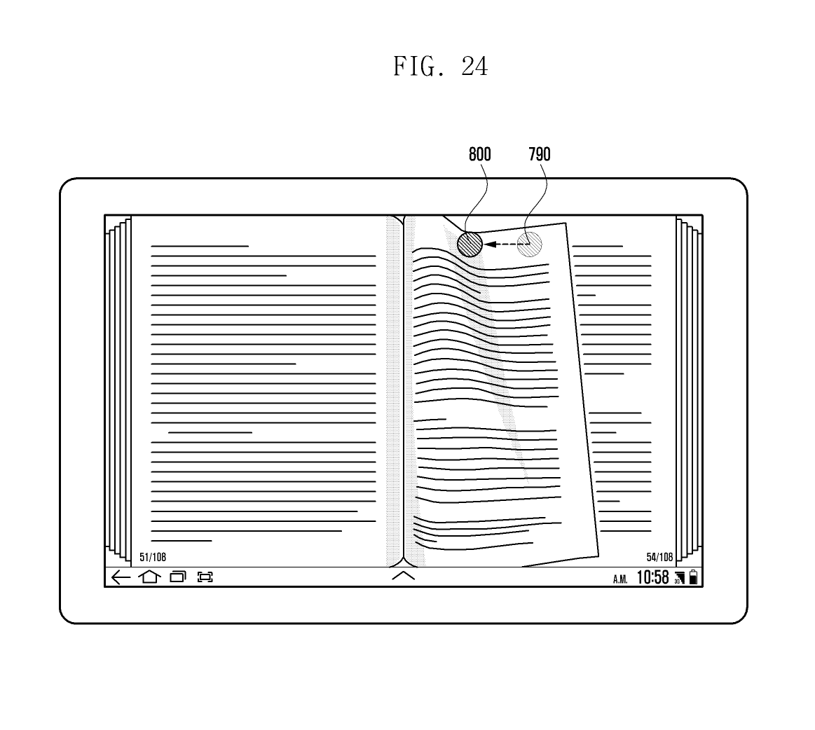

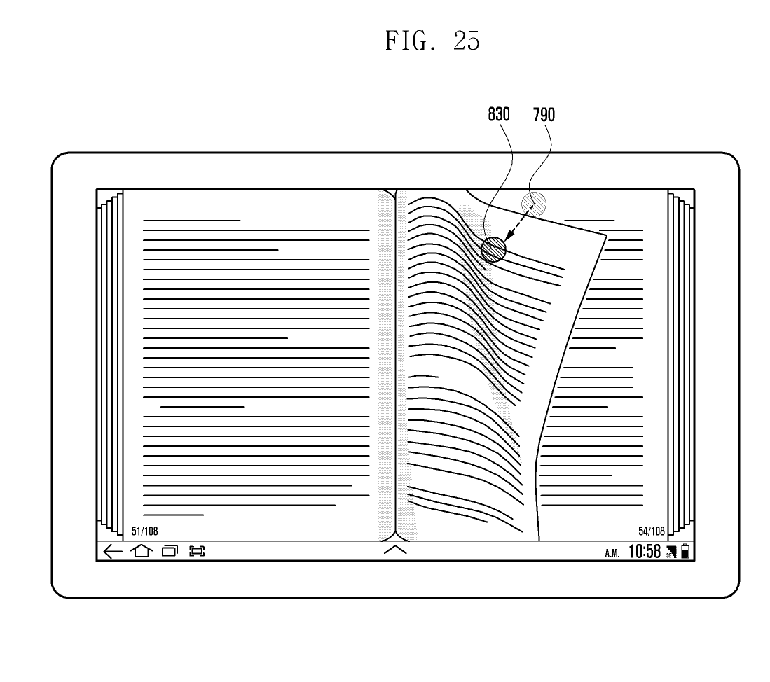

Referring to FIGS. 24 and 25, the user may move the touch input unit from the first upper point 790 to the second upper point 800. The user may move the touch input unit from the first upper point 790 of the page to the fourth upper point 830. Comparing FIG. 25 with FIG. 24, the first touched points in FIGS. 24 and 25 are the same but moving directions thereof are different from each other. Accordingly, shapes of transformed pages in FIGS. 24 and 25 may be different from each other.

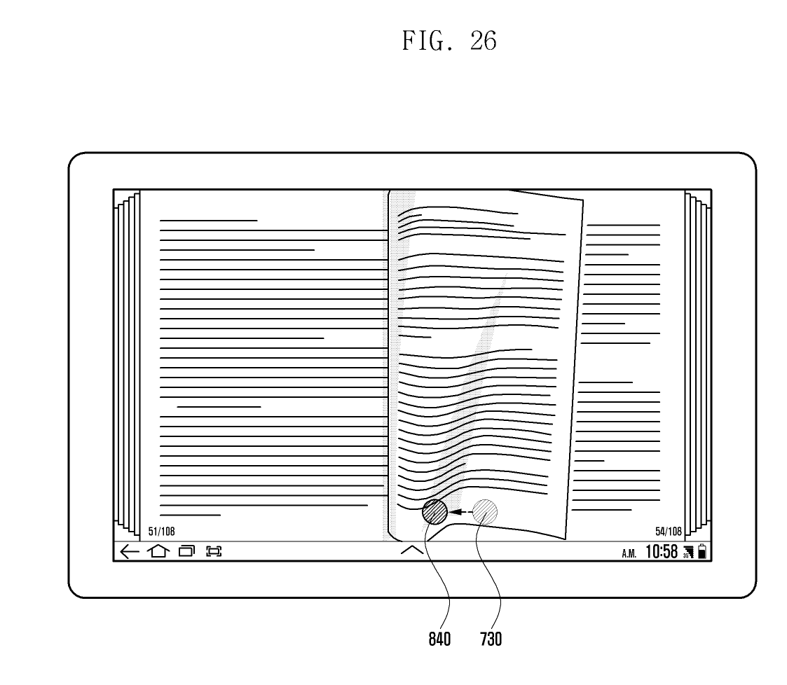

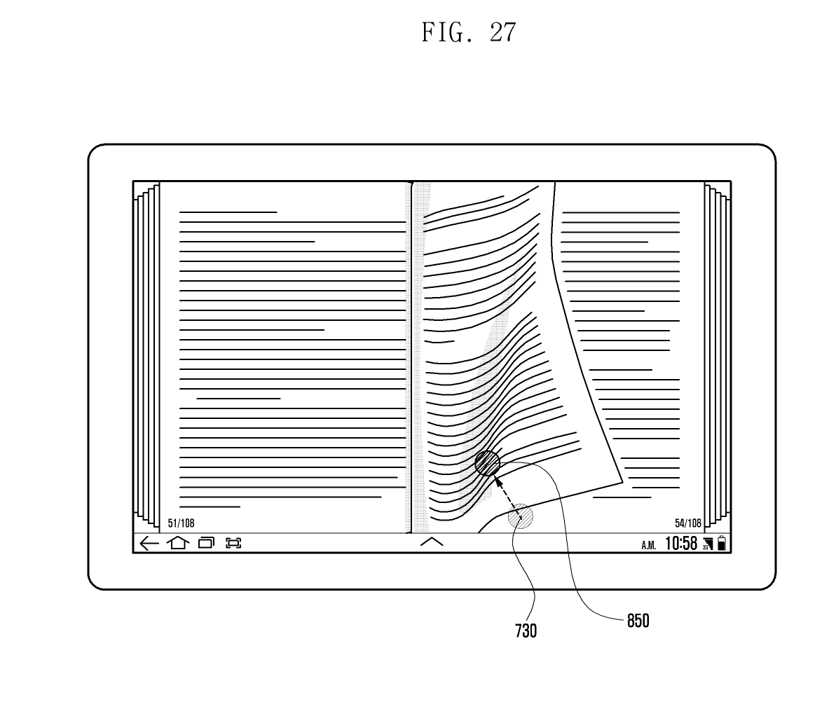

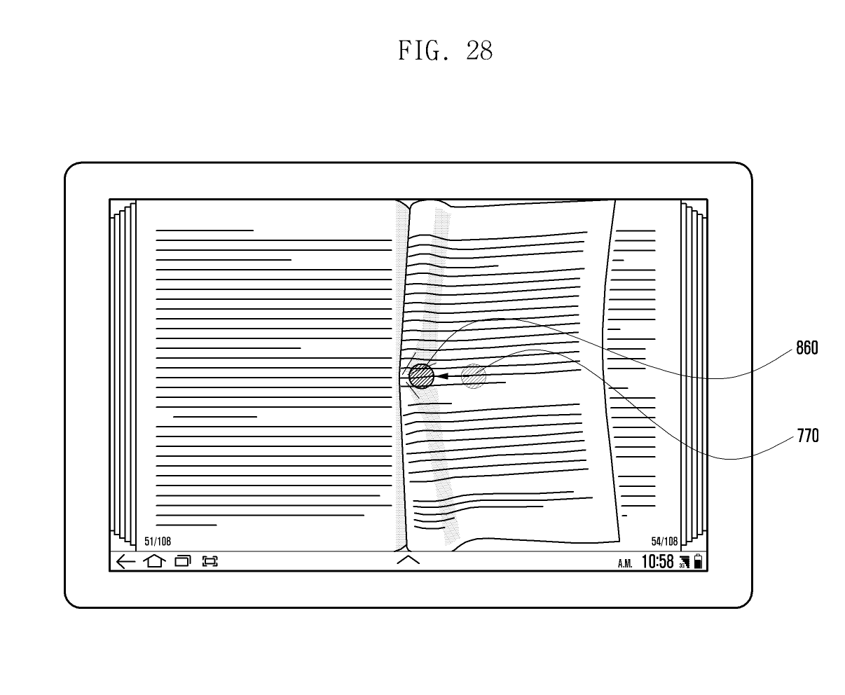

Next, referring FIG. 26, the user may move the touch input unit from the second lower point 730 of the page to the first left lower corner 840. Referring to FIG. 27, the user may move the touch input unit from the second lower point 730 of the page to the second lower corner 850 located higher than the first left corner 840. Referring to FIG. 28, the user may move the touch input unit from the first left point 770 to the second left point 860 located at a left side of the first left point 770.

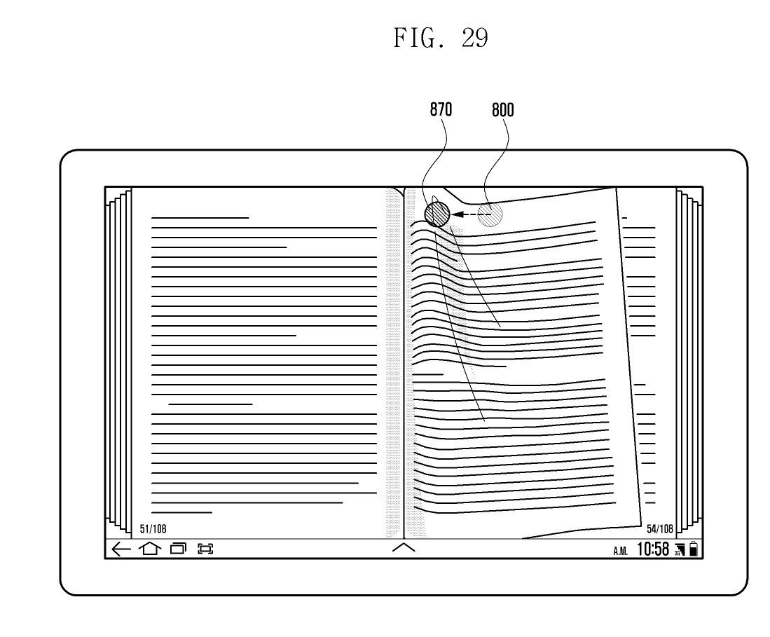

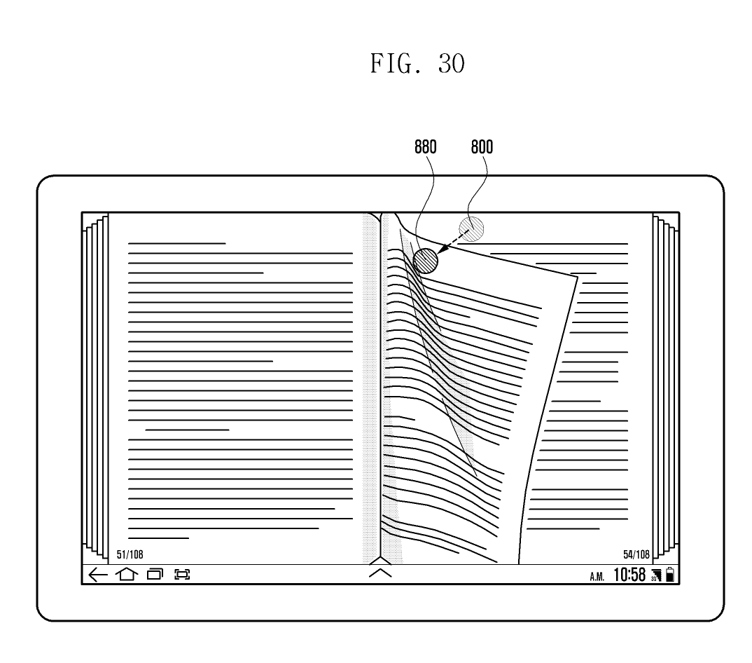

Referring to FIG. 29, the user may move the touch input unit from the second upper point 800 to the first left upper corner 870. Referring to FIG. 30, the user may move the touch input unit from the second upper point 800 of the page to the second left upper point 880 located lower than the first left upper corner 870. In addition to the touched points described in FIGS. 9 to 30, the user may touch all points of the page. Accordingly, the page may be transformed according to the touched location, the moving direction, and speed of the touch gesture.

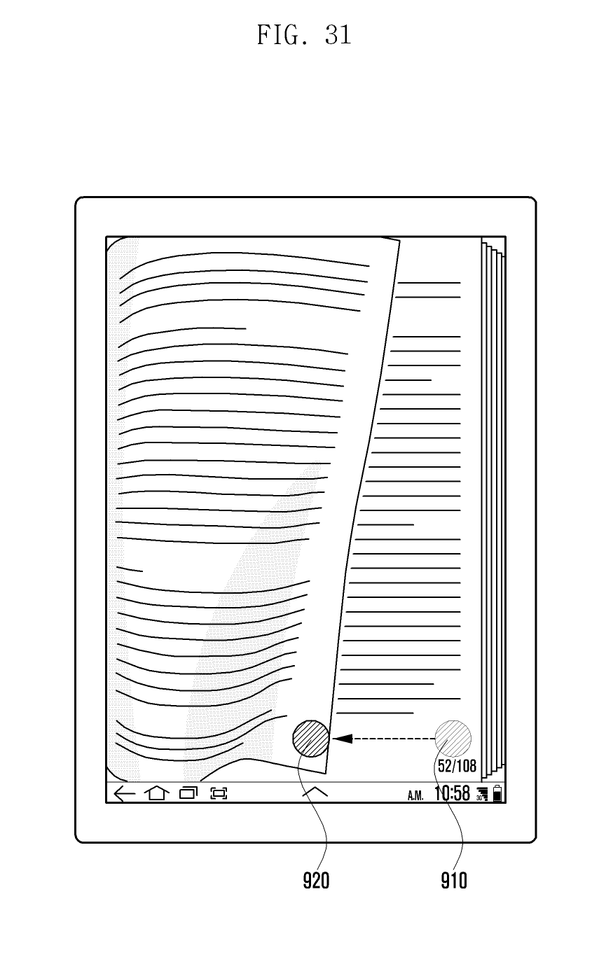

As shown in FIGS. 31 to 33, a display mode may be a portrait mode. The display unit 112 may display one page in the portrait mode. Referring to FIG. 31, the user may touch the touch input unit at the right lower corner 910 of the page. Accordingly, the controller 190 detects a target node corresponding to the right lower corner 910. The user may move the touch input unit towards the left lower corner in a touched state of the right lower corner 910. Accordingly, the controller 190 moves the target node towards the left lower corner. The controller 190 calculates a displacement of the moved target node. In detail, the controller 190 calculates a current location, moving speed, and a moving distance of the target node. Next, the controller 190 calculates forces applied to respective nodes using the calculated displacement. The controller 190 then calculates locations of the respective nodes using the calculated forces and generates an animation using the calculated locations. The controller 190 controls the display unit 112 to display the generated animation. As described above, FIG. 31 illustrates an animation when the touch input unit is moved from the right corner 910 towards the left lower corner and is located at the lower point 920. If the touch input unit approaches a left side within a preset threshold (e.g., 10 mm from a left side of the screen), the controller 190 may turn the page and control the display unit 112 to display a next page (e.g., page 53).

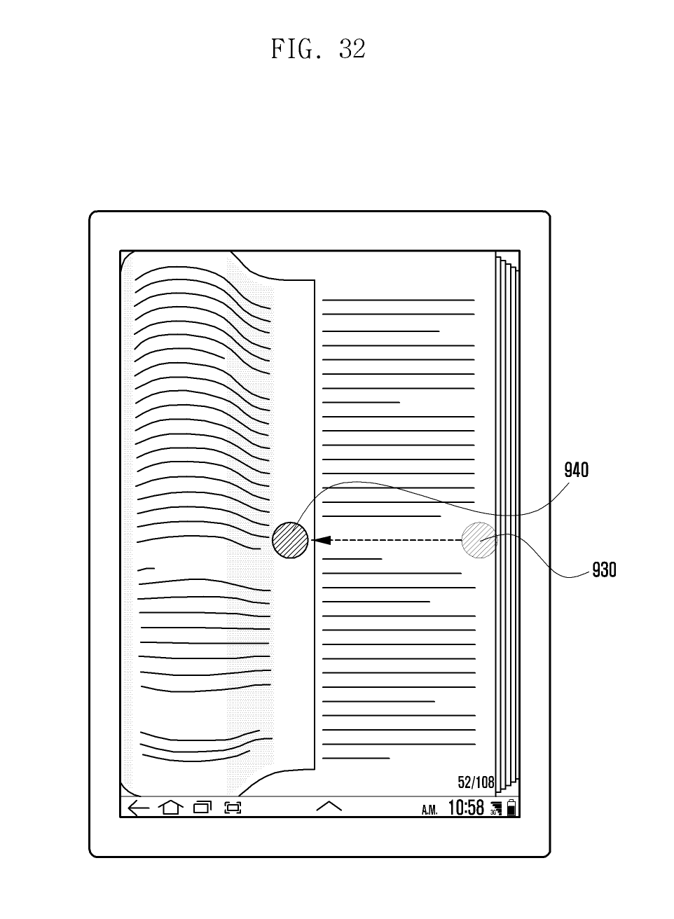

Referring to FIG. 32, the user may touch the touch input unit at a right point 930 and then move the touch input unit towards an opposite side, that is, a left side. That is, FIG. 32 illustrates an animation when the touch input unit is moved from the right point 930 towards the left side and is located in the central point 940. If the touch input unit approaches the left side within a preset threshold (e.g., 10 mm from the left side of the screen), the controller 190 may turn the page and control the display unit 112 to display a next page (e.g., page 53).

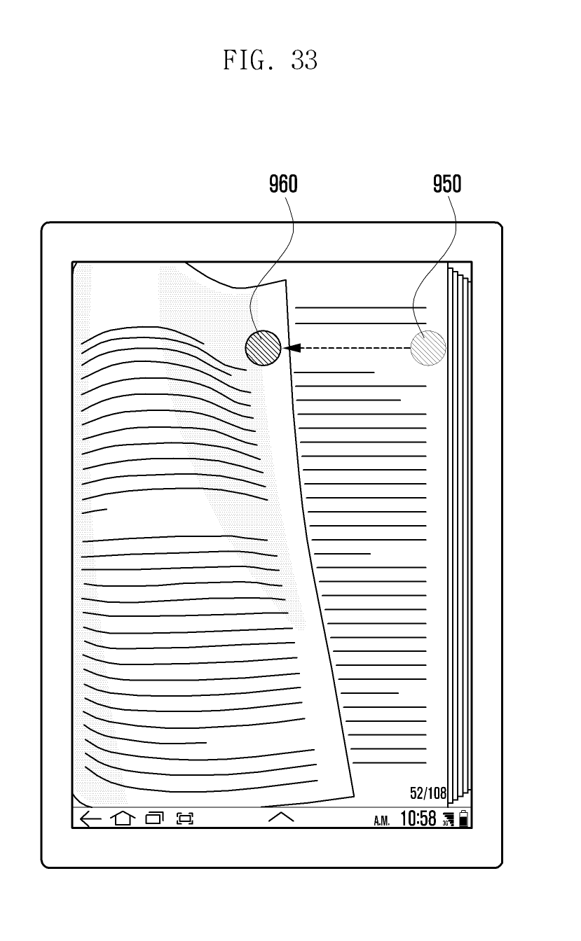

Referring to FIG. 33, the user may touch the touch input unit the right upper corner 950 of the page and move the touch input unit in a direction of the left corner. That is, FIG. 33 illustrates an animation when the touch input unit is moved from the right upper corner 950 to the left upper corner and is located at the upper point 960. If the touch input unit approaches the left side within a preset threshold (e.g., 10 mm from the left side of the screen), the controller 190 may turn the page and control the display unit 112 to display a next page (e.g., page 53).

As described above, as illustrated with reference to the exemplary diagrams of screens, the page may be variously transformed according to the first touched point, the current touched point, and the moving direction and the moving distance of the touch. Particularly, as illustrated in FIGS. 12, 13, and 16, if the touch input unit is moved from the left side to the right side through the central line, a rear surface of the currently operated page may be displayed. Although not shown, when the touch input unit is moved from the right side to the left side, in the same manner, the rear surface may be displayed. Even if the touch input unit does not pass through the central line, the rear surface of the current operated page may be displayed. For example, if the touch input unit approaches a central line within a preset threshold (e.g., 10 mm from the central line), the controller 190 may display the display unit 112 to display the rear surface.

As illustrated with reference to exemplary diagrams of the screens, if the touch is released, the page may be moved according to a direction of a weight center of the page. A direction of the weight center may be associated with at least one of the current touched point, a moving direction of the touch, a first touched point, and a moving distance of the touch. In a case as illustrated in FIGS. 12, 13, and 16, that is, when the touch input unit passes through the central line separating the left and right pages and then the touch is released, the page may be turned.

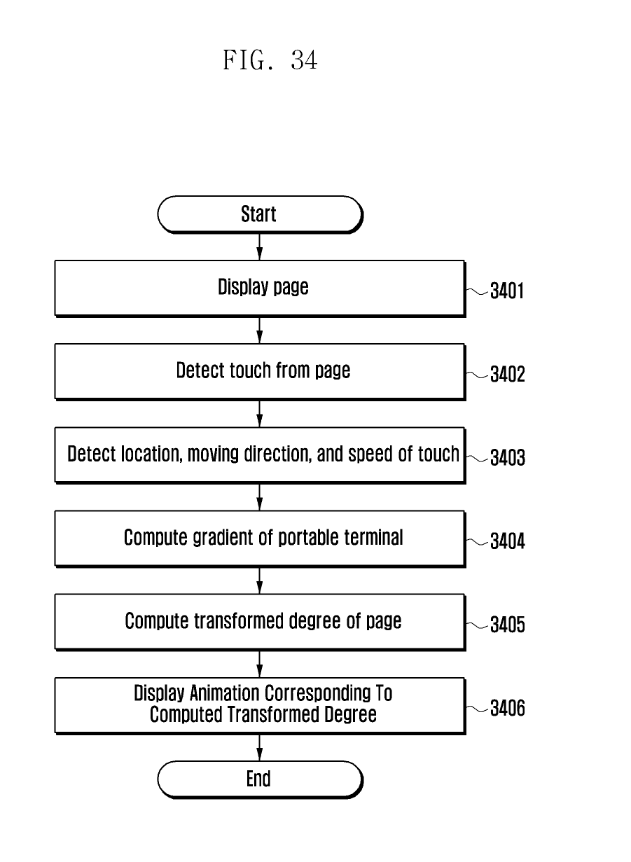

FIG. 34 is a flowchart illustrating a method of displaying a page according to another embodiment. It is assumed that the page turning mode is a merge mode. Referring to FIG. 34, the display unit 112 may display a page under control of the controller 190 (3401). For example, the display unit 120 displays a home screen including an icon for executing an e-book App. The controller 190 may detect a touch associated with an execution request of the e-book App. If the execution request of the e-book App is detected, for example, the controller 190 reads a finally stored page from an e-book read by the user, and controls the display unit 112 to display the page. The controller 190 detects a touch from the displayed page (3402). If the touch is detected, the controller 190 detects a location, a moving direction, and speed of the touch (3403), and computes a gradient of the portable terminal 100 (3404). The controller 190 computes a transformed degree of the page based on touch information (e.g., the location, moving direction, and speed) detected at operation 3403 and gradient information (e.g., roll angle φ, pitch angle θ, and yaw angle ψ) (3405). In the computation of the transformed degree, attribute information (e.g., material, thickness, weight, etc.) of the page may be considered together with the touch information and gradient information. In the computation of the transformed degree, residual information (e.g., the number of pages put on left and right sides when the display mode is a landscape mode) may be considered together with the touch information and gradient information. The controller 190 generates an animation corresponding to the computed transformed degree and controls the display unit 112 to display the animation (3406). If the e-book is executed, the sensor 185 may be driven by the controller 190 and measure and provide a gravity acceleration to the controller 190. That is, when the page turning mode is the merge mode, the controller 190 may compute a gradient of the portable terminal before the touch is detected. Accordingly, operation 3404 may be performed before operation 3402. When the page turning mode is the normal mode, although receiving gravity acceleration information from the sensor 185 according to execution of another application, the controller 190 may not compute a gradient. The gradient is computed, but is not reflected onto the transformation of the page at operation 3405.

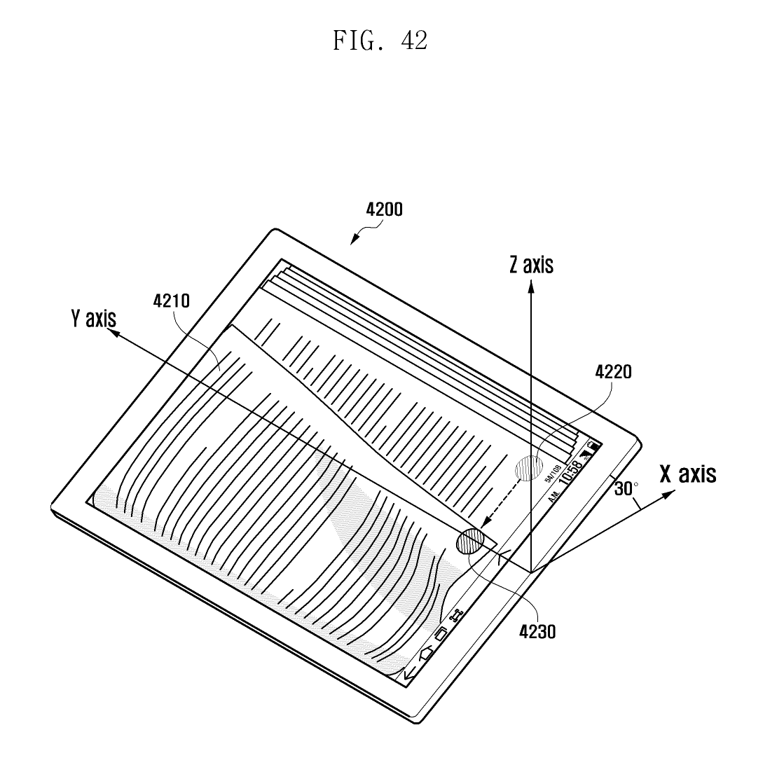

FIGS. 35 to 44 are exemplary diagrams illustrating a screen for describing a method of displaying screens according to another embodiment. It is assumed that the page turning mode is the merge mode. As described above, the controller 190 may convexly transform the page based on the touch information (e.g., location, moving direction, and speed) and gradient information (e.g., roll angle φ, pitch angle θ, and yaw angle ψ). Although the shape of the page becomes convex, a concrete form may be changed according to the touch information and the gradient information. In FIGS. 35 to 41, a display mode of the portable terminal is a landscape mode. In FIGS. 42 to 44, the display mode of the portable terminal is a portrait mode.

Referring to FIG. 35, the portable terminal 3500 is in a state that a front surface of the portable terminal 3500 with a touch screen faces upward, and a rear surface of the portable terminal 3500 is placed on a horizontal surface (e.g., surface of the table). In this state, X and Y axis components of a gravity acceleration measured by the sensor 185 may be measured to have 0 m/sec², and only Z axis component may be measured to have +9.8 m/sec². The controller 190 computes a gradient of the portable terminal 3500 using acceleration information with respect to each axis received from the sensor 185. For example, the controller 190 may compute the roll angle φ, the pitch angle θ, and the yaw angle ψ. Among the angles, the controller 190 may not compute the yaw angle ψ. In the state of the portable terminal 3500 shown in FIG. 35, the computed gradient (φ, θ, ψ) of the portable terminal 350 may be (0, 0, 0).

Referring to FIG. 36, a portable terminal 3600 is in a state that a front surface of the portable terminal 3600 with a touch screen faces upward, and a rear surface of the portable terminal 3500 faces downward. For example, the user holds the portable terminal 3600 in a hand. The touch screen of the portable terminal 3600 displays the first page 3610 and the second page 3620 on a left side and a right side of the screen. The user may touch the touch input unit at a right lower corner 3630 of the second page 3620, and move the touch input unit from the right lower corner 3630 towards the first lower point 3640. In this case, the controller 190 detects a touched location, a moving distance, a moving direction, and speed of the touch from a touch event input from the touch screen. In the example of FIG. 36, the computed touched location may include XY coordinates corresponding to the right lower corner 3630 and XY coordinates corresponding to the first lower point 3640. The computed moving distance of the touch may include a straight line distance (e.g., 6 cm) between the right lower corner 3630 and the first lower point 3640. The computed moving direction may include a value (e.g., 0°) indicating a left side. The detected speed of the touch may include time information (e.g., 0.5 second) taken where the touch input unit is moved from the right lower point 3630 to the first lower point 3640. The controller 190 computes a gradient of the portable terminal 3600 using acceleration information input from the sensor 185. In the example of FIG. 36, the computed gradient information (φ, θ, ψ) may be (0, 30, 0). The controller 190 computes a transformed degree of the second page 3620 based on the detected touch information (e.g., touched location, moving distance, moving direction, and speed, etc.) and the computed gradient. In the computation of the transformed degree, attribute information (e.g., material, thickness, weight, etc.) of the page may be considered together with the touch information of the gradient information. The attribute information of the page may not be considered. Whether to consider the attribute information of the page may be set by the user. As illustrated in FIG. 36, the controller 190 convexly transforms the second page 3620 based on the computed transformed degree.

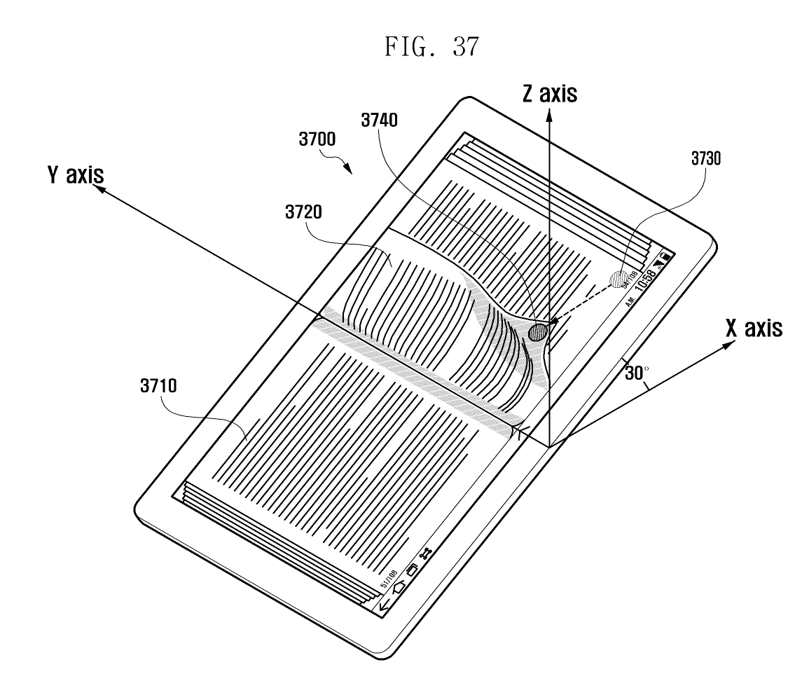

Referring to FIG. 37, a touch screen of a portable terminal 3700 displays a first page 3710 and a second page 3720 on a left side and a right side of a screen, respectively. The user may touch the touch input unit at a right lower point 3730 of the second page 3720, and move the touch input unit from the right lower point 3730 towards the center of the second page 3720 to locate it in the second lower point 3740. In this case, the controller 190 detects the touched location, a moving distance, a moving direction, and speed of the touch from a touch event input from the touch screen. In a case of an example of FIG. 37, the computed touched location may include XY coordinates corresponding to the right lower corner 3730 and XY coordinates corresponding to the second lower point 3740. The computed moving distance of the touch may include a straight line distance (e.g., 7 cm) between the right lower corner 3730 and the second lower point 3740. The computed moving direction may include a value (e.g., 30°) indicating a direction of the center in the right lower corner. The detected speed of the touch may include time information (e.g., 0.5 second) taken where the touch input unit is moved from the right lower corner 3730 to the first lower point 3740. The controller 190 computes a gradient of the portable terminal 3700 using acceleration information input from the sensor 185. In the example of FIG. 37, the computed gradient information (φ, θ, ψ) may be (0, 30, 0). The controller 190 computes a transformed degree of the second page 3720 based on the detected touch information (e.g., touched location, moving distance, moving direction, and speed, etc.) and the computed gradient. As illustrated in FIG. 37, the controller 190 convexly transforms the second page 3720 based on the computed transformed degree.

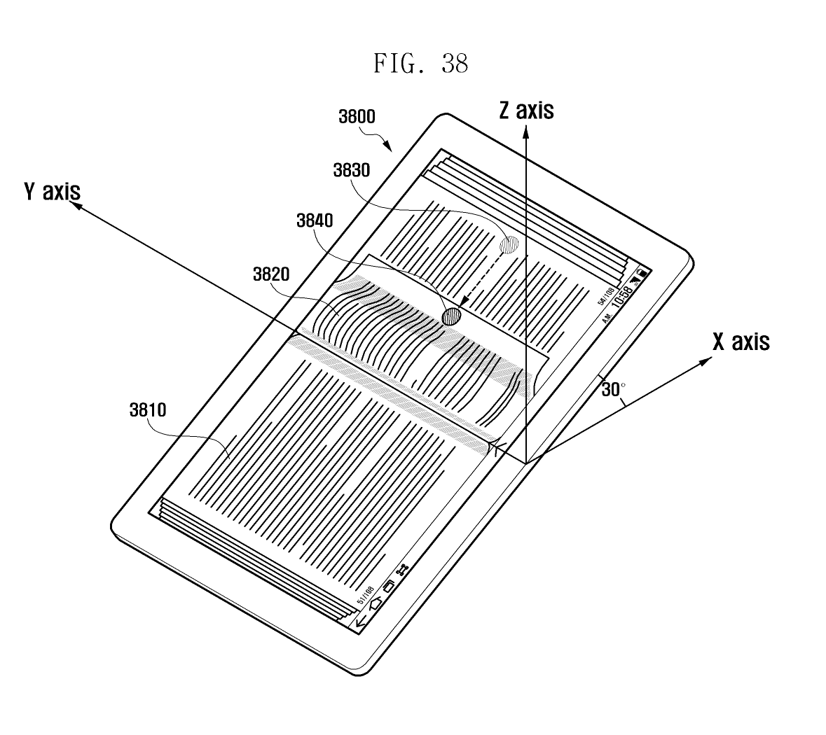

Referring to FIG. 38, a touch screen of a portable terminal 3800 displays a first page 3810 and a second page 3820 on a left side and a right side of a screen, respectively. The user touches the touch input unit at a right point 3830 of the center of the second page 3820, and then moves the touch input unit from the right point 3830 towards an opposite side, that is, a left side of the second page 3820, thereby locating the touch input unit at a central point 3840. In the example of FIG. 38, the computed touched location from the controller 190 may include XY coordinates corresponding to the right lower corner 3830 and XY coordinates corresponding to the second lower point 3840. The computed moving distance of the touch may include a straight line distance (e.g., 7 cm) between the right point 3830 and the central point 3840. The computed moving direction may include a value (e.g., 0°) indicating a left side. The detected speed of the touch may include time information (e.g., 0.5 second) taken where the touch input unit is moved from the right point 3830 to the central point 3840. The controller 190 computes a gradient of the portable terminal 3800 using acceleration information input from the sensor 185. The computed gradient information (φ, θ, ψ) may be (0, 30, 0). The controller 190 computes a transformed degree of the second page 3820 based on the detected touch information and the computed gradient information. As illustrated in FIG. 38, the controller 190 convexly transforms the second page 3820 based on the computed transformed degree.

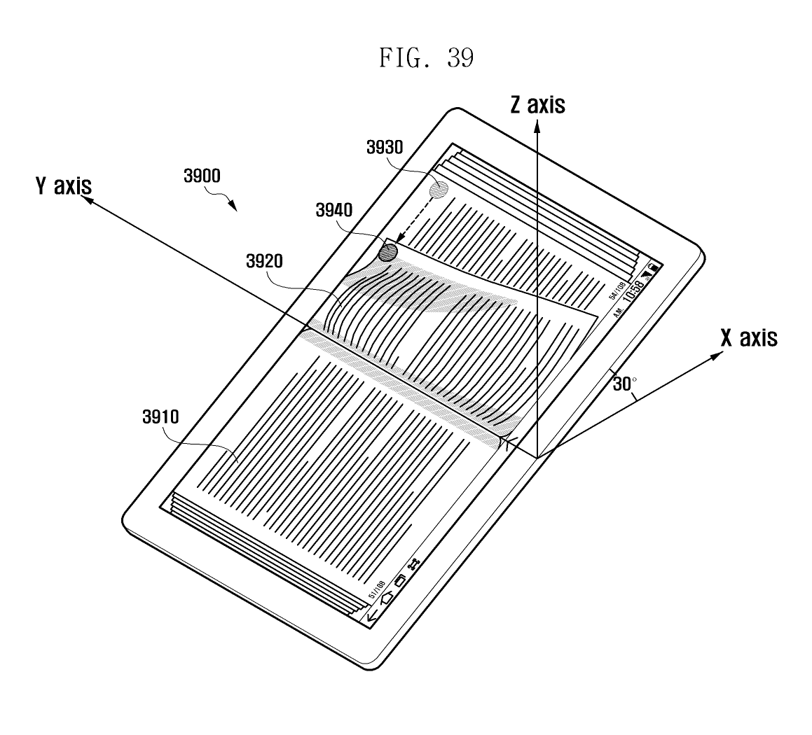

Referring to FIG. 39, a touch screen of a portable terminal 3900 displays a first page 3910 and a second page 3920 on a left side and a right side of a screen, respectively. The user may touch the touch input unit at a right upper corner 3930 of the second page 3920 and then move the touch input unit from the right upper corner 3930 towards a left upper corner of the second page 3920, thereby locating the touch input unit at the first upper point 3940. In the example of FIG. 39, the computed touched location may include XY coordinates corresponding to the right upper corner 3930 and XY coordinates corresponding to the first upper point 3940. The computed moving distance of the touch may include a straight line distance (e.g., 7 cm) between the right upper corner 3930 and the first upper point 3940. The computed moving direction may include a value (e.g., 0°) indicating a left side. The detected speed of the touch may include time information (e.g., 0.5 second) taken where the touch input unit is moved from the right upper corner 3930 to the first upper point 3940. The computed gradient information (φ, θ, ψ) may be (0, 30, 0). The controller 190 computes a transformed degree of the second page 3920 based on the detected touch information and the computed gradient information. As illustrated in FIG. 39, the controller 190 convexly transforms the second page 3920 based on the computed transformed degree.

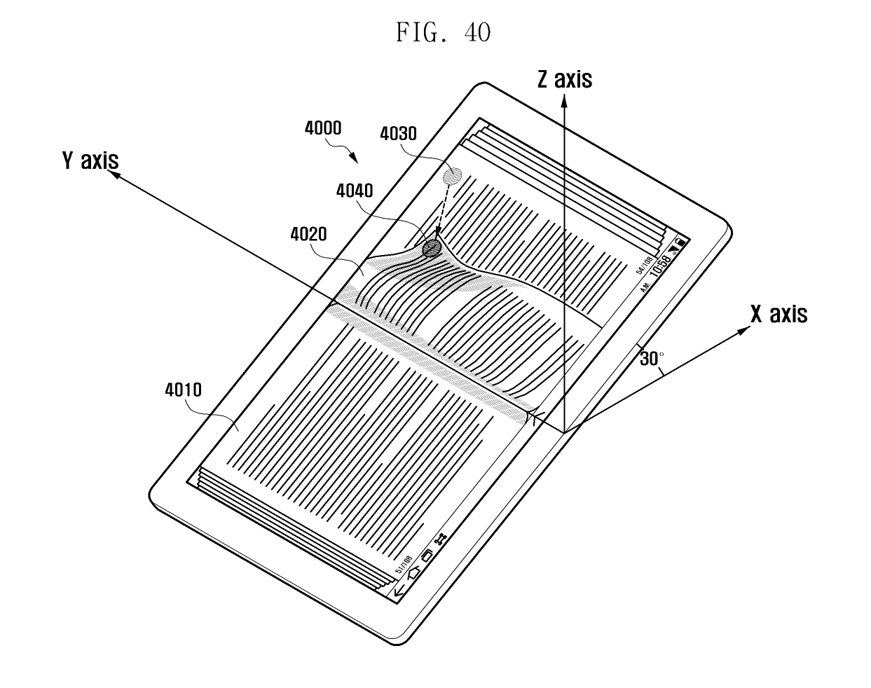

Referring to FIG. 40, a touch screen of a portable terminal 4000 displays a first page 4010 and a second page 4020 on a left side and a right side of a screen, respectively. The user may touch the touch input unit at a right upper corner 4030 of the second page 4020 and then move the touch input unit from the right upper corner 4030 towards the center of the second page 4020, thereby locating the touch input unit at the second upper point 4040. In the example of FIG. 40, the computed touched location may include XY coordinates corresponding to the right upper corner 4030 and XY coordinates corresponding to the second upper point 4040. The computed moving distance of the touch may include a straight line distance (e.g., 7 cm) between the right upper corner 4030 and the second upper point 4040. The computed moving direction may include a value (e.g., −30°) indicating a direction of the center. The detected speed of the touch may include time information (e.g., 0.5 second) taken where the touch input unit is moved from the right upper corner 4030 to the second upper point 4040. The computed gradient information (φ, θ, ψ) may be (0, 30, 0). The controller 190 computes a transformed degree of the second page 4020 based on the detected touch information and the computed gradient information. As illustrated in FIG. 40, the controller 190 convexly transforms the second page 4020 based on the computed transformed degree.

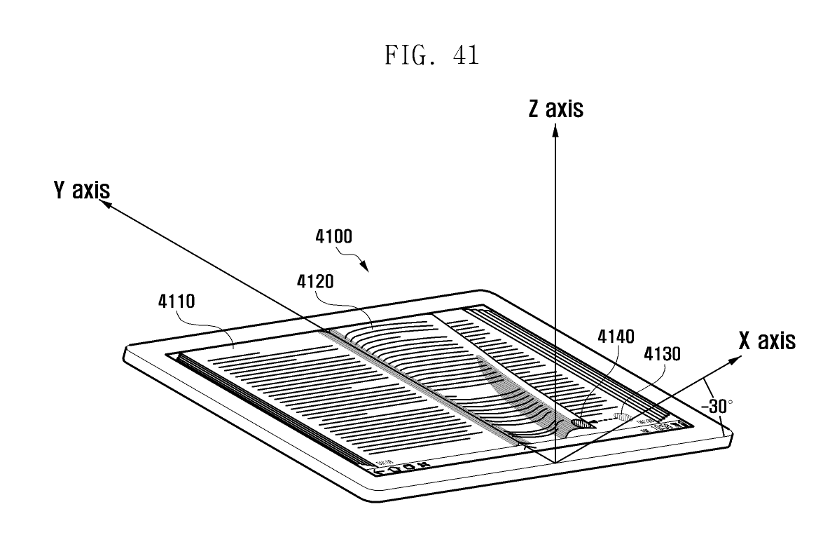

Referring to FIG. 41, a touch screen of a portable terminal 4100 displays a first page 4110 and a second page 4120 on a left side and a right side of a screen, respectively. The user may touch the touch input unit at a right lower corner 4130 of the second page 4120 and then move the touch input unit from the right lower corner 4130 towards the left lower corner of the second page 4120, thereby locating the touch input unit at the first lower upper point 4140. In the example of FIG. 41, the computed touched location may include XY coordinates corresponding to the right lower corner 4130 and XY coordinates corresponding to the first point 4140. The computed moving distance of the touch may include a straight line distance (e.g., 6 cm) between the right lower corner 4130 and the first upper point 4140. The computed moving direction may include a value (e.g., 0°) indicating the left side. The detected speed of the touch may include time information (e.g., 0.5 second) taken where the touch input unit is moved from the right lower corner 4130 to the first lower point 4140. The computed gradient information (φ, θ, ψ) may be (0, −30, 0). The controller 190 computes a transformed degree of the second page 4120 based on the detected touch information and the computed gradient information. As illustrated in FIG. 41, the controller 190 convexly transforms the second page 4120 based on the computed transformed degree.

As described above, in FIGS. 36 to 41, turned pages are all convex. However, it is appreciated that shapes of transformed pages may be changed according to touch information (e.g., touched location, moving distance, moving direction, and speed) and gradient information (e.g., roll angle φ, pitch angle θ, and yaw angle ψ). For example, comparing FIG. 37 with FIG. 36, and of FIG. 40 with FIG. 39, the touch input units starts from the same point but moving directions are different from each other. Accordingly, shapes of transformed pages are different from each other, respectively.

Referring to FIG. 36, if the touch is moved from the right lower corner 3630 of the second page 3820 to the first lower point 3640, a lower portion of the second page 3820 is biased to the left side as compared with the upper portion thereof. Referring to FIG. 38, if the touch is moved from a right point 3830 of the second page 3820 to the central point 3840, the second page 3820 is uniformly turned without being biased. Referring to FIG. 39, if the touch is moved from a right upper corner 3930 of the second page 3920 to the first upper point 3940, the upper portion of the second page 3920 is biased to the left side as compared with the lower portion thereof.

Comparing FIG. 41 with FIG. 36, the touch information, for example, the touched location, the moving distance, the moving direction, and the speed are the same. In a case of FIG. 36, the gradient (φ, θ, ψ) of the portable terminal is (0, 30, 0), in a case of FIG. 41, the gradient (φ, θ, ψ) of the portable terminal is (0, −30, 0). That is, the portable terminal of FIG. 36 is inclined in a turning direction of the page, and the portable terminal of FIG. 41 is inclined opposite to the turning direction of the page.

Accordingly, it is appreciated that shapes of transformed pages may be changed according to a gradient of the portable terminal. For example, as shown in FIGS. 36 and 41, as the pitch angle θ become larger, the page becomes convex. Meanwhile, the user may touch the touch screen with the touch input unit at any point of the page in addition to the foregoing points to move the page to some directions. The page may be easily turned according to gradient information of the portable terminal. For example, the portable terminal is inclines toward a turning direction of the page. In this state, when a touch is moved to a turning direction (e.g., from right lower corner to left lower corner), the convexly transformed page may be easily turned. Page turning in a case where a turning direction of the page is different from the gradient of the portable terminal is not easy as compared with a case where the turning direction of the page is the same as the gradient of the portable terminal. That is, there is a need for movement and speed of many touches. For convenience of the description, in FIGS. 36 to 41, the gradient information is limited to one axis, that is, a Y axis, but the gradient of the portable terminal may generally be “φ≠0, θ≠0, and ψ≠0”. That is, three axes x, y, and z may all be inclined. In this case, the controller 190 may compute a convexly transformed degree of the page based on gradient information of three axes.

Referring to FIG. 42, a touch screen of the portable terminal 3600 displays a first page 4210. The user may touch the touch screen with the touch input unit at a right lower corner 4220 of the first page 4210 and move the touch input means from the right lower corner 4220 to a left lower corner of the second page 4210, thereby locating the touch input unit at a lower point 4230. In a case of an example of FIG. 42, the computed touched location may include XY coordinates corresponding to the right lower corner 4220 and XY coordinates corresponding to the lower point 4230. The computed moving distance of the touch may include a straight line distance (e.g., 6 cm) between the right lower corner 4220 and the lower point 4230. The computed moving direction may include a value (e.g., 0°) indicating the left side. The detected speed of the touch may include time information (e.g., 0.5 second) taken where the touch input unit is moved from the right lower corner 4220 to the lower point 4230. The computed gradient information (φ, θ, ψ) may be (0, 30, 0). The controller 190 computes a transformed degree of the first page 4210 based on the detected touch information (e.g., touched location, moving distance, moving direction, and speed) and the computed gradient information. As illustrated in FIG. 42, the controller 190 convexly transforms the first page 4120 based on the computed transformed degree.

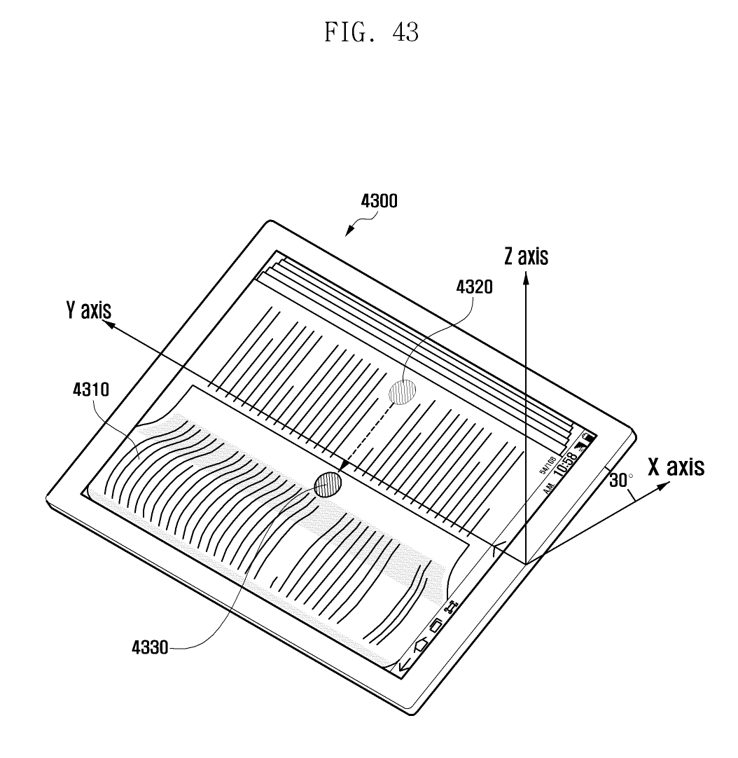

Referring to FIG. 43, the touch screen of the portable terminal 4300 displays a first page 4310 on a left side and a right side of a screen, respectively. The user may touch the touch screen with the touch input unit at a right point 4320 of the center of the first page 4310 and then move the touch input unit from the right point 4320 towards an opposite side, that is, the left side of the first page 4310, thereby locating the touch input unit at the central point 4330. In a case of an example of FIG. 43, the computed touched location may include XY coordinates corresponding to the right point 4320 and XY coordinates corresponding to the central point 4330. The computed moving distance of the touch may include a straight line distance (e.g., 7 cm) between the right point 4320 and the central point 4330. The computed moving direction may include a value (e.g., 0°) indicating the left side. The detected speed of the touch may include time information (e.g., 0.5 second) taken where the touch input unit is moved from the right point 4320 to the central point 4330. The computed gradient information (φ, θ, ψ) may be (0, 30, 0). The controller 190 computes a transformed degree of the first page 4320 based on the detected touch information (e.g., touched location, moving distance, moving direction, and speed) and the computed gradient information. As illustrated in FIG. 43, the controller 190 convexly transforms the first page 4310 based on the computed transformed degree.

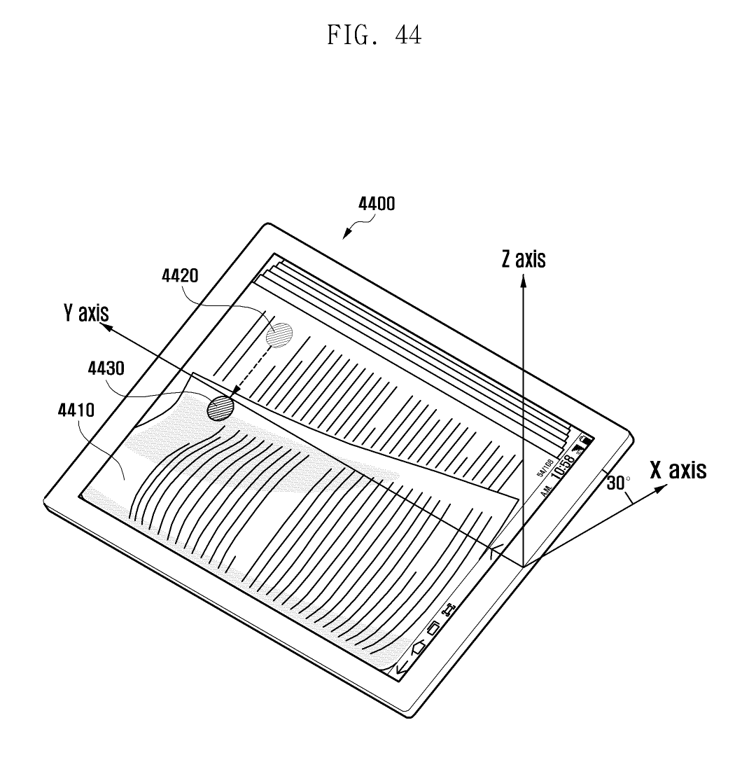

Referring to FIG. 44, a touch screen of the portable terminal 4400 displays a first page 4410 on a left side and a right side of a screen, respectively. The user may touch the touch input unit at a right upper corner 4420 of the first page 4410 and then move the touch input unit from the right upper corner 4420 to the left upper corner of the first page 4410, thereby locating the touch input unit at the upper point 4430. In a case of an example of FIG. 44, the computed touched location may include XY coordinates corresponding to the right upper corner 4420 and XY coordinates corresponding to the first upper point 4430. The computed moving distance of the touch may include a straight line distance (e.g., 7 cm) between the right upper corner 4420 and the upper point 4430. The computed moving direction may include a value (e.g., 0°) indicating the left side. The detected speed of the touch may include time information (e.g., 0.5 second) taken where the touch input unit is moved from the right upper corner 4420 to the upper point 4430. The computed gradient information (φ, θ, ψ) may be (0, 30, 0). The controller 190 computes a transformed degree of the first page 4410 based on the detected touch information (e.g., touched location, moving distance, moving direction, and speed) and the computed gradient information. As illustrated in FIG. 44, the controller 190 convexly transforms the first page 4410 based on the computed transformed degree.

As described above, in FIGS. 42 to 44 with each other, turned pages are all convex. However, it is appreciated that shapes of transformed pages may be changed according to touch information (e.g., touched location, moving distance, moving direction, and speed) and gradient information (e.g., roll angle φ, pitch angle θ, and yaw angle ψ). For example, referring to FIG. 42, if the touch is moved from a right lower corner 4220 of the first page 4210 to a lower point 4230, a lower portion of the first page 4210 is biased to the left side as compared with the upper portion thereof. Referring to FIG. 43, if the touch is moved from a right point 4320 of the first page 4310 to the central point 4330, the first page 4310 is uniformly turned without being biased to one direction. Referring to FIG. 44, if the touch is moved from a right upper corner 4420 of the first page 4410 to the upper point 4430, the upper portion of the first page 4410 is biased to the left side as compared with the lower portion thereof. Meanwhile, the user may touch the touch screen with the touch input unit at any point of the page in addition to the foregoing points to move the page to some directions. The page may be easily turned according to gradient information of the portable terminal. For example, the portable terminal is inclines toward a turning direction of the page. In this state, when a touch is moved to a turning direction (e.g., from right lower corner to left lower corner), the convexly transformed page may be easily turned. Page turning in a case where a turning direction of the page is different from the gradient of the portable terminal is not easy as compared with a case where the turning direction of the page is the same as the gradient of the portable terminal. That is, there is a need for movement and speed of many touches. For convenience of the description, in FIGS. 42 to 44, the gradient information is limited to one axis, that is, a Y axis, but the gradient of the portable terminal may generally be “φ≠0, θ≠0, and ψ≠0”. That is, all of three axes x, y, and z may be inclined. In this case, the controller 190 may compute a convexly transformed degree of the page based on gradient information of three axes.

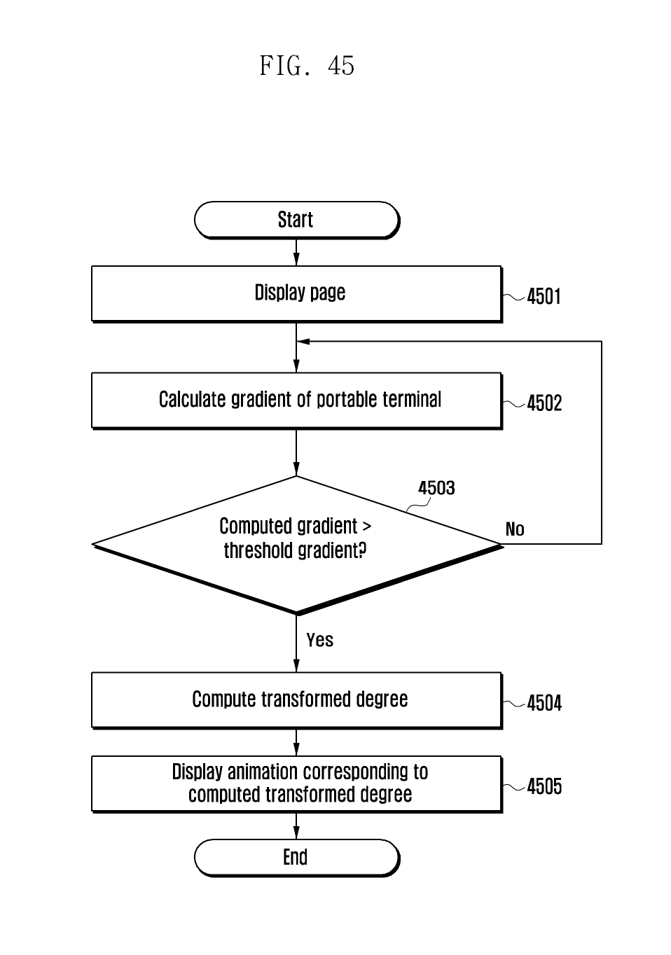

FIG. 45 is a flowchart illustrating a method of displaying a page according to still another embodiment. It is assumed that the page turning mode is a gradient mode. Referring to FIG. 45, a display unit 112 may display a page under control of a controller 190 (4501). For example, the display unit 112 displays a home screen including an icon for execution an e-book App. The controller 190 may detect a touch associated with an execution request of an e-book. As described above, if the execution request of the e-book App is detected, the controller 190 reads a finally stored page from a previously viewed e-book and controls the display unit 112 to display the read page. The controller 190 calculates a gradient of the portable terminal 100 using acceleration information received from the sensor 185 (4502). The controller 190 determines whether the computed gradient exceeds a preset threshold gradient, for example, whether a pitch angle exceeds 60° (4503). When the computed gradient exceeds a preset threshold gradient, the controller 190 computes a transformed degree based on the gradient information (e.g., roll angle φ, pitch angle θ, and yaw angle ψ) computed at operation 4502 (4504). In the computation of the transformed degree, attribute information (e.g., material, thickness, weight, etc.) of the page may be considered together with the touch information and gradient information. In the computation of the transformed degree, residual information (e.g., the number of pages put on left and right sides when the display mode is a landscape mode) may be considered together with the touch information and gradient information. The controller 190 generates an animation corresponding to the computed transformed degree, and controls the display unit 112 to display the animation (4505).

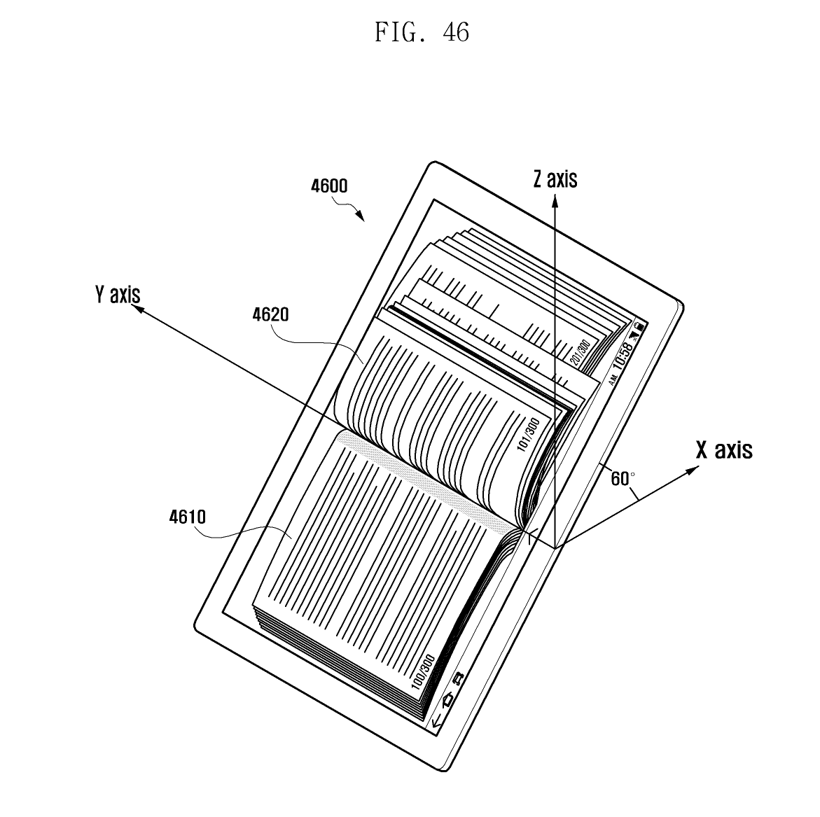

FIG. 46 is an exemplary diagram illustrating a screen for describing a method of displaying screens according to still another embodiment. It is assumed that a page turning mode is the gradient mode. As described above, the controller 190 may convexly transform the page based on the touch information (e.g., location, moving direction, and speed) and gradient information (e.g., roll angle φ, pitch angle θ, and yaw angle ψ). Although the shape of the page becomes convex, a concrete form may be changed according to the touch information and the gradient information.

Referring to FIG. 46, a portable terminal 4600 is in a state that a front surface of the portable terminal 4600 with a touch screen faces upward, and a rear surface of the portable terminal 4600 faces downward. The display mode of the portable terminal 4600 is a landscape mode. The touch screen of the portable terminal 4600 displays the first page 4610 and the second page 4620 on a left side and a right side of the screen, respectively. In this case, as shown in FIG. 46, the user may incline the pitch angle θ at 60°. Then, the gradient of the portable terminal 4600 is changed and the controller 190 computes the gradient of the portable terminal 4600 using acceleration information input from the sensor 185. For example, the computed gradient of the portable terminal 100 is (0, 0, 60) as shown in FIG. 46. The controller 190 computes a transformed degree of the page based on the computed gradient information, and generates and displays an animation corresponding to the computed result. For example, as shown in FIG. 46, when a gradient (φ, θ, ψ) of the portable terminal 4600 is (0, 0, 60) and the display mode is a landscape mode on which two pages are displayed on left and right sides of a screen, and a residual amount of pages put on the right side of the screen is page 200, the controller 190 may generate and display in which 100 pages are turned to the left side. In this case, the 100 pages may be turned at one time. A plurality of pages may be sequentially turned. When the pitch angle θ is less than 60°, one page may not be turned to the left side. That is, the 60° is a threshold angle in which the page starts to be turned to the left side. The threshold gradient may be changed according to a residual amount of pages put at a left side of the screen. The threshold gradient may be changed according to attribute information (e.g., material, thickness, or weight) of the page. Although not shown, when a gradient (φ, θ, ψ) of the portable terminal 100 is (0, 0, 70), and the display mode is a landscape mode in which two pages are displayed left and right, the controller 190 may generate and display an animation in which 150 pages are turned to the left side.

As shown in FIGS. 9 to 33, and FIGS. 36 to 44, the controller 190 according to the exemplary embodiments may represent a shadow effect to a folded part of the page. In detail, to process the folded part with shadow, the controller 190 computes a normal vector in each coordinate of the page and calculates an angle between the normal vector and a light source vector heading for a light source. If the calculated angle is less than a preset threshold (e.g., 10°), the controller 190 regards that corresponding coordinates directly faces the light source and processes the coordinates brightly. If the calculated value is greater than a preset threshold, corresponding coordinates are regarded that light does not reach from the light source and the coordinates are processed darkly. The light source may be regarded to be located at a perpendicular line with respect to the page. The controller 190 may process a dark degree by levels. For example, if the calculated value is greater than the first threshold (e.g., 10°) and is less than the second threshold (e.g., 20°), corresponding coordinates are processed slightly darkly. If the calculated value is greater than the second threshold, the corresponding coordinates may be processed more darkly. Meanwhile, the shadow effect has various known techniques. A shadow effect is possible in the page in various methods as well as the foregoing methods.

Methods for displaying a page according to exemplary embodiments as described above may be implemented in an executable program command form by various computer means and be recorded in a computer readable recording medium. In this case, the computer readable recording medium may include a program command, a data file, and a data structure individually or a combination thereof. In the meantime, the program command recorded in a recording medium may be specially designed or configured for the present invention or be known to a person having ordinary skill in a computer software field to be used. The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, flash memory storing and executing program commands. Further, the program command includes a machine language code created by a complier and a high-level language code executable by a computer using an interpreter. The foregoing hardware device may be configured to be operated as at least one software module to perform an operation, and a reverse operation thereof is the same.

As described above, according to the method and the apparatus for displaying a page according to the exemplary embodiments, when the user reads an e-book, an actual feeling may be transferred to the user similar to the user reading a paper book.

Although exemplary embodiments have been described in detail hereinabove, it should be clearly understood that many variations and modifications of the basic inventive concepts herein taught which may appear to those skilled in the present art will still fall within the spirit and scope of the inventive concept, as defined in the appended claims.

What is claimed is:

1. A method of displaying a page in a terminal, the method comprising:
displaying a page of an electronic book;
detecting a point which corresponds to a user input with respect to the displayed page;
detecting a moving direction associated with the user input; and
displaying the page as being convexly curved in response to the detected point and the moving direction associated with the user input to animate a page turning operation.

2. The method of claim 1, wherein the displaying of the page as being convexly curved comprises moving the point at an angle determined according to with a virtual gravity force applied to the page so that the surface of the displayed page is three-dimensionally convexly curved during the animation of the page turning operation.

3. The method of claim 2, wherein the displaying of the page as being convexly curved comprises:
detecting a target node corresponding to the point among nodes in a page mesh including the nodes and links connecting the nodes to each other;
moving the target node to the moving direction to transform the page mesh; and
reflecting the transformed page mesh onto the page,
wherein a weight is allocated to the nodes so that the gravity is applied to the nodes, and an elastic value is allocated to the links so that the transformed page is spread.

4. The method of claim 3, wherein the transforming the page mesh comprises:
determining a displacement of the target node;
determining forces applied to the nodes using the determined displacement; and
determining locations of the nodes using the determined forces.

5. The method of claim 4, wherein the displacement comprises at least one of a current location of the target note, a moving direction of the target node, and speed of the target node.

6. The method of claim 4, further comprising:
summing the forces applied to the nodes to determine a direction of a force applied to the transformed page; and
moving the transformed page in the determined direction of the force when it is detected that the pointer is released from touching the screen.

7. The method of claim 1, further comprising:
determining a direction of a force applied to the transformed page based on at least one of a first point, a current point, a moving distance, and the moving direction of the pointer; and
moving the transformed page in the determined direction of the force when it is detected that the pointer is released from touching the screen.

8. The method of claim 1, further comprising moving the transformed page in the moving direction of the pointer when it is detected that the pointer is released from touching the screen.

9. The method of claim 1, wherein the displaying of the page as being convexly curved comprises convexly transforming the page according to a moving speed of the pointer.

10. The method of claim 1, further comprising outputting an effect sound in response to the convexly transforming the page.

11. The method of claim 1, wherein the displaying of the page as being convexly curved comprises transforming the page so that only a front surface of the page is displayed.

12. The method of claim 11, wherein the displaying of the page of the electronic book comprises displaying two pages of electronic book at left and right sides of the screen, respectively, and
the displaying of the page as being convexly curved comprises displaying a rear surface of the page when the pointer passes through a central line separating the two pages.

13. A method of displaying a page in a terminal, the method comprising:
displaying a page of an electronic book;
detecting a point which corresponds to a user input with respect to the page; and
displaying the page as being convexly curved in response to the detected point associated with the user input to animate a page turning operation.

14. An apparatus for displaying a page, the apparatus comprising:
a display unit configured to display the page;
an input unit configured to receive input information of a pointer touching the screen with respect to the page; and
a controller configured to receive the input signal from the input unit, detect a point which corresponds to a user input with respect to the page based on the input signal, detect a moving direction associated with the user input, and control the display unit to display the page as being convexly curved in response to the detected point and the moving direction associated with the user input to animate a page turning operation.

15. The apparatus of claim 14, wherein the input unit comprises a touch screen configured to generate and transfer a touch event to the controller in response to a touch gesture of a user that is made with the pointer.

16. A non-transitory computer-readable recording medium storing a program that is executed by a terminal to perform a method of displaying a page in the terminal, the method comprising:
displaying a page of an electronic book;
detecting a point which corresponds to a user input with respect to the displayed page;
detecting a moving direction associated with the user input; and
displaying the page as being convexly curved in response to the detected point and the moving direction associated with the user input to animate a page turning operation.

17. A method of displaying a page of a portable terminal including a touch screen, the method comprising:
displaying a page of an electronic book;
detecting a continuous motion of a touch of the touch screen with respect to the displayed page;
determining a gradient of the portable terminal; and
displaying the page as being convexly curved in response to the detected continuous motion of the touch and the determined gradient of the portable terminal to animate a page turning operation.

18. The method of claim 17, wherein the displaying of the page as being convexly curved comprises convexly transforming the page to turn the transformed page.

19. The method of claim 18, wherein in the displaying of the page as being convexly curved, the page is increasingly convexly transformed as the portable terminal is inclined toward a turning direction of the page.

20. The method of claim 18, wherein in the displaying of the page as being convexly curved, the page is decreasingly convexly transformed as the portable terminal is inclined opposite to a turning direction of the page.

21. The method of claim 18, wherein the displaying of the page as being convexly curved comprises convexly transforming the page corresponding to attribute information set in the page.

22. The method of claim 17, wherein the detecting of the continuous motion of the touch comprises at least one of a location, a moving direction, a moving direction, and speed of the touch.

23. The method of claim 17, further comprising providing at least one of an effect sound and a haptic in response to the transforming the page.

24. A method of displaying a page of a portable terminal including a touch screen, the method comprising:
displaying a page of an electronic book;
computing a gradient of the portable terminal; and
displaying the page as being convexly curved in response to the computed gradient of the portable terminal to animate a page turning operation.

25. The method of claim 24, wherein the displaying of the page as being convexly curved comprises convexly transforming the page to turn the transformed page.

26. The method of claim 25, wherein the displaying of the page as being convexly curved comprises turning at least one page when the computed gradient exceeds a threshold gradient.

27. The method of claim 26, wherein the threshold gradient corresponds to at least one of a number of remaining pages of the electronic book and attribute information set in the page.

28. A method of displaying a page of a portable terminal including a touch screen, the method comprising:
displaying a page of an electronic book on the touch screen;
determining a page turning mode; and
selectively determining a gradient of the portable terminal according to the page turning mode.

29. The method of claim 28, wherein the page turning mode comprises one of a normal mode, a gradient mode, and a merge mode.

30. The method of claim 29, further comprising:
detecting a continuous motion of a touch of the touch screen with respect to the page; and
convexly transforming the page using only the continuous motion of the touch when the page turning mode is the normal mode, and displaying the transformed page.

31. The method of claim 29, further comprising convexly transforming the page using only the computed gradient when the page turning mode is the gradient mode, and displaying the transformed page.

32. The method of claim 29, further comprising convexly transforming the page using the continuous motion of the touch and the computed gradient when the page turning mode is the merge mode, and displaying the transformed page.

33. A portable terminal comprising:
a touch screen configured to display a page of an electronic book;
a sensor configured to detect a gradient of the portable terminal; and
a controller configured to detect a continuous motion of a touch of the screen with respect to the displayed page, and control the touch screen to display the page as being convexly curved in response to the detected continuous motion of the touch and the detected gradient of the portable terminal to animate a page turning operation.
